(19) United States
(12) Patent Application Publication
(10) Pub. No.: US 2008/0176746 A1
(43) Pub. Date: Jul. 24, 2008

(54) OIL SUSPENSION CONCENTRATE COMPRISING MICROENCAPSULATED AGROCHEMICALLY ACTIVE COMPOUNDS

(75) Inventors: Ralph GROHS, Dusseldorf (DE); Roland Deckwer, Frankfurt (DE); Frank Rosenfeldt, Langenfeld (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience AG, Monheim (DE)

(21) Appl. No.: 12/017,846

(22) Filed: Jan. 22, 2008

(30) Foreign Application Priority Data
Jan. 23, 2007 (EP) EP2007/001380

(51) Int. Cl. A01N 25/28; A01N 47/36; A01N 43/647; A01P 13/00; A01N 43/38; A01N 47/34

(52) U.S. Cl. 504/211; 504/359; 504/329; 504/261; 504/284

(57) ABSTRACT

The present invention relates to an oil suspension concentrate comprising microencapsulated agrochemically active compounds. The inventive oil suspension concentrate advantageously comprises
(a) one or more agrochemically active compounds in the aqueous phase, which is present in encapsulated form in the oil phase, and
(b) one or more agrochemically active compounds in the oil phase,
   and also if desired, any customary auxiliaries and/or additives.

### CROSS REFERENCE TO RELATED APPLICATION

This application claims priority to EP 07001380.0 filed Jan. 23, 2007, the content of which is incorporated herein by reference in its entirety.

### BACKGROUND OF THE INVENTION

1. Field of the Invention

The present invention relates generally to oil suspension concentrate comprising microencapsulated agrochemically active compounds, and in particular, the invention relates to oil suspension concentrates for crop protection and to the agrochemically active compounds comprised therein, which are present in encapsulated form.

2. Description of Related Art

In a microcapsule the coat of the capsule is a wall of polymers that physically separates two liquid phases outside and inside the capsule. Accordingly, the term “microcapsule” has to be distinguished from other formulation forms, such as, for example, emulsion, microsphere, liposome, since these types of materials do not physically separate liquids inside and outside a capsule by a wall consisting of polymers.

A distinction is made between “oil-in-water microencapsulation” and “water-in-oil microencapsulation”.

In the case of oil-in-water microencapsulation, an emulsion of oil-in-water is present, i.e. the water-immiscible or water-insoluble material is surrounded by the polymer material of the microcapsule. In contrast, in the case of water-in-oil microencapsulation, the aqueous phase is inside the microcapsule. Accordingly, it is also referred to as “inverse microencapsulation”. In the case of multi-microencapsulation, a distinction is made between the “water-in-oil-in-water microencapsulation” and the “water-in-oil-in-oil microencapsulation”.

Suitable preparation processes for making the microencapsulation forms mentioned are known. Such microencapsulated products can be employed in various areas, for example in food production, pharmacy, colorant chemistry, agrochemistry, etc.

In the case of oil-in-water microencapsulation, the microcapsules are formed starting with an oil-in-water emulsion from the monomers and prepolymers present in the oil droplets under the action of heat and/or by pH change and/or by mechanical stirring. The treatment in question causes the monomer or the prepolymers to polymerize. Processes of this type are disclosed, for example, in the U.S. Pat. Nos. 4,285,720 and 4,956,129.

EP 1 282 353 B1 discloses the combination of crop protection agents with organic or inorganic carrier materials for the controlled release of the active compounds. The use of the oil-in-water microencapsulation is also contemplated. The combinations disclosed in EP '353 permit the antagonization of other active compounds to be suppressed in mixtures with these, and at the same time they make time- and work-intensive split applications redundant. The problem of chemical incompatibility between active compounds is not part of the subject-matter of EP 1 282 353 B1.

Water-in-oil microcapsules are prepared from a water-in-oil emulsion by the “water-in-oil process”. Such a process is disclosed in U.S. Pat. No. 4,157,983. A corresponding process which uses two monomers and prepolymers is disclosed in U.S. Pat. No. 4,534,783.

A process for multiple microencapsulation, the so-called continuous multimicroencapsulation process, is disclosed in WO 2005/058476 A1. This is a continuous process for microencapsulation water-in-oil-in-water by in situ interfacial polymerization of the corresponding emulsion. The active compounds enclosed in the microcapsules promote health and are suitable for other biological purposes. The use of the process for formulating agrochemically active compounds or for solving the problem of chemical incompatibility between agrochemically active compounds is not contemplated in WO '476.

A further particular process for making a “water-in-oil microencapsulation” is disclosed in WO 98/28957 A. Here, the wall of the microcapsules is formed in the presence of an active surface proton transfer proton catalyst by in situ self-condensation of the prepolymers located at the interface between aqueous and organic phase in the aqueous phase, by input of heat. The active substance which, according to the teaching of WO 98/28975 A, may also comprise a pesticide, is located in the aqueous phase inside the microcapsules. Moreover, the organic phase may also comprise a pesticide as a biologically active material. As pesticides in the aqueous phase, WO 98/28957 A mentions paraquat, diquat, glyphosate, dicamba, acifluorfen, fomesafen, ioxynil, bromoxynil, bentazone, atrazine and azoxystrobin. Oil-soluble herbicides which are mentioned are EPTC, butylate, cycloate, molinate, vernolate, acetochlor, metolachlor, alachlor, butachlor, propachlor and trifluralin. Insecticides which are mentioned are parathion, malathion, ionofos, permethin, lambda-cyhalothrin, deltamethrin, tralomethrin, cypermethrin and tefluthrin, and a fungicide mentioned is azoxystrobin. Optionally, use may also be made of safeners. The problem of chemical incompatibility between two or more agrochemically active compounds is not addressed by WO 98/28957 A.

The congress contribution “Reverse Phase Microcapsule Suspension of Glyphosate Isopropylamine Salt in Hydrocarbon Fluids in Combination with Herbicidal Partners” from the year 2002 (10th IUPAC International Congress on the Chemistry of Crop Protection Basel 2002, presented by P. Y. Guyomar, Exxon Mobil Chemical, Book of Abstracts Topics 1-4, Vol. 1, 4c. 19) discloses the use of the herbicide glyphosate, dissolved in water, in microencapsulated form (glyphosate capsule suspension (CS) in oil fluids) in combination with the oil-soluble herbicide lactofen present in the oil phase, in addition to the microcapsules. It was demonstrated that the glyphosate/lactofen formulation can be stored for more than three months and that, in the spray tank, there were no coherbicide incompatibilities between the specifically mentioned herbicides.

The congress contribution mentioned above addresses in a general manner the incompatibility of two herbicides. With lactofen, the coherbicide proposed for the oil phase is a herbicide distinguished by low solubility in water, i.e. by high solubility in oil, and at the same time by a low sensitivity to hydrolysis. A differentiated study or a proposed solution for the multi-layer problem of incompatibility, in particular when coherbicides sensitive to hydrolysis are used, is thus not disclosed in this congress contribution.

In principle, in the formulation of active compounds from the class of the sulfonylureas, their sensitivity toward hydrolysis always has to be taken into account. The formulation techniques established to date ensure their chemical stability very efficiently as long as the sulfonylureas are employed as individual active compounds or in combination with other sulfonylureas or else with safeners. However, making a formulation of a sulfonylurea in combination with one or more active compounds or auxiliaries whose structure contains an acid function and/or free OH groups remains a challenge. Active compounds known for their hydrolysis-inducing potential toward sulfonylureas are, for example, glufosinate and glyphosate. The low pH of glyphosate (<7) is harmful for sulfonylureas which are stable in the basic range.

The chemical incompatibility of active compounds is a multi-layered problem. In addition to container stability or storage stability, the stability of the active compound after dilution of the concentrate in the spray tank may be a problem. Until the active compound is applied by spraying, crystallization has to be prevented and the distributability and the biological activity of the active compound have to be ensured.

### SUMMARY OF THE INVENTION

It was an object of the present invention to provide an improved liquid formulation of crop protection agents with at least two agrochemically active compounds where each compound, in particular any chemically unstable active compounds present in the formulation, and the formulation as a whole have high chemical and physical stability and also high biological effectiveness and crop plant compatibility.

It was a further object of the present invention to provide a liquid formulation that generally avoids antagonistically reduced activity or overdosage otherwise requiring split applications.

Surprisingly, it has now been found that these and other objects can be achieved, for example, by employing an oil suspension concentrate of the present invention.

Accordingly, the present invention relates to an oil suspension concentrate comprising
(a) At least one agrochemically active compound in an aqueous phase, which is present in encapsulated form in an oil phase, and
(b) At least one agrochemically active compound in an oil phase, encapsulated, and
(c) optionally an auxiliary and/or additive.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### DETAILED DESCRIPTION OF A PREFERRED EMBODIMENT

The present invention advantageously involves water-in-oil microencapsulation, unless a multi-microencapsulation process is employed. As mentioned above, in the case of multi-microencapsulation, a distinction is made between the “water-in-oil-in-water microencapsulation” and the “water-in-oil-in-oil microencapsulation”. In the context of the present invention, in principle, both techniques can be employed, with the water-in-oil-in-oil microencapsulation being particularly advantageous in some embodiments.

In one embodiment of the present invention, there are many possible alternatives contemplated.

According to some alternatives, a central objective is, in the case of a combination of active compounds, to protect an active compound which is more sensitive to hydrolysis by providing any other active compound which may possibly have a hydrolysis-inducing potential in a microencapsulated form. If an active compound is included and is sensitive to hydrolysis, any other compound in the formulation that has a hydrolysis-inducing potential is provided in a microencapsulated form. So in connection with a preferred embodiment of the present invention, there can be a water-in-oil microencapsulation (more preferred), or an oil-in-water microencapsulation. Or if a multi microencapsulation is employed, there can be a water-in-oil-in-water multi microencapsulation or else a water-in-oil-in-oil multi microencapsulation.

In a first alternative, an oil suspension concentrate is proposed which comprises at least two different agrochemically active compounds, at least one of which, active compound (a) is water-soluble and present in a microcapsule. At least one further active compound, i.e. active compound (b), is dispersed or dissolved in the oil phase, and is also in encapsulated form.

Thus, in this first alternative, at least two active compounds which differ, for example, in their solubility and/or in their sensitivity to hydrolysis are microencapsulated. As a result of providing these two active compounds both in microencapsulated form, the active compound which is more sensitive to hydrolysis is provided with additional protection against the active compound which is less sensitive to hydrolysis and has a hydrolysis-inducing potential.

The additional microencapsulation of the active compounds better dispersed or dissolved in the oil phase may additionally have the advantage that, by virtue of the different release times of the differently encapsulated active compounds, split applications can be minimized and often avoided.

In a second alternative, an oil suspension concentrate is used which comprises at least two different agrochemically active compounds, at least one of which is present within a microcapsule and at least one is present in the oil phase is not encapsulated. The active compound which is present in the oil phase in nonencapsulated form is advantageously an acetolactate synthase (ALS) inhibitor. Thus, according to the approach of this second alternative, the additional microencapsulation of any active compound dispersed or dissolved in the oil phase is dispensed with.

In a third alternative, an oil suspension concentrate is used which comprises at least two different agrochemically active compounds, at least one of which is present within a microcapsule and at least one of which is present in an oil phase and is not encapsulated. In this alternative, the microencapsulated active compound is preferably an acetolactate synthase (ALS) inhibitor and the active compound having a high hydrolysis-inducing potential is present in the oil phase and is not encapsulated. Thus, according to the approach of the third alternative, the additional microencapsulation of the hydrolysis-inducing active compounds is dispensed with.

In the context of the present invention and according to another alternative, what is also contemplated is an oil suspension concentrate comprising at least two different agrochemically active compounds, at least one of which is present within a microcapsule and at least one of which is present in an oil phase and is not encapsulated. In this alternative, the active compound which is present in the oil phase and is not encapsulated preferably comprises a phosphorus-containing herbicide.

According to an additional independent approach, it is contemplated that the active compounds can be treated, for example, in accordance with the multimicroencapsulation process in WO 2005/058476 A1 (incorporated herein by reference in relevant portion) and are present in a corresponding form. In the case of the water-in-oil-in-oil microencapsulation, to protect the active compound(s) sensitive to hydrolysis, the hydrolysis-inducing active compound(s) can be present, if desired, in the core of the capsule. In contrast, the active compound which is sensitive to hydrolysis can be present in the oil phase of the oil suspension concentrate, since the oil phase is where such a hydrolysis sensitive compound is often best protected.

Thus, the oil suspension concentrate can advantageously comprise at least two different agrochemically active compounds, at least one active compound being water-soluble and at least one active compound being present dispersed or dissolved in the oil phase. The active compounds can be treated by a multimicroencapsulation process and can be present in a corresponding form.

According to its mechanism of action, the compound class of the sulfonylureas belongs to the group of the ALS inhibitors. These types of compounds inhibit the enzyme acetolactate synthase (ALS) and thus the protein synthesis in the plants.

Hereinbelow, the definitions used to describe the invention are illustrated in more detail.

The term oil suspension concentrate (OD, oil dispersion) is to be understood as meaning a suspension concentrate based on organic water-immiscible solvents. Here, one or more active compounds or safeners are suspended in the organic solvent. Further active compounds or safeners may be dissolved in the organic solvent.

In the context of the present invention, the term agrochemically active compound comprises herbicides, plant growth regulators and safeners, i.e. the oil suspension concentrates according to the invention may also comprise one or more safeners where, in addition to the active compound, the safener, too, may be present in microencapsulated form. Possible safeners are mentioned hereinbelow in an exemplary manner in connection with the agrochemically active compounds. Furthermore, the oil suspension concentrates according to the invention may comprise one or more inorganic salts and also customary auxiliaries and additives.

Examples of specific agrochemically active compounds include:

### Herbicides

Examples of herbicides include, for example, ALS inhibitors (acetolactate synthetase inhibitors) or herbicides from the group of the carbamates, thiocarbamates, haloacetanilides, substituted phenoxy-, naphthoxy- and phenoxyphenoxycarboxylic acid derivatives and also heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic esters, cyclohexanedione derivatives, imidazolinone, phosphorus-containing herbicides, for example of the glufosinate type or of the glyphosate type, pyrimidinyloxypyridinecarboxylic acid derivatives, pyrimidyloxybenzoic acid derivatives, triazolopyrimidinesulfonamide derivatives and also S-(N-aryl-N-alkylcarbamoylmethyl)dithiophosphoric esters, ureas and hydroxybenzonitriles. Here, in the case of the present invention, the herbicides from the group of the carbamates, thiocarbamates, haloacetanilides are typically not contemplated as active compounds present in the oil phase. In contrast, carbamates, thiocarbamates, haloacetanilides can be present in the aqueous phase in the microcapsules present in the oil suspension concentrate.

In the context of the present invention, the herbicidally active compounds from the group of the ALS inhibitors, such as sulfonylureas, are, in addition to the neutral compounds, in each case also to be understood as including salts thereof with inorganic and/or organic counterions. Thus, for example, sulfonylureas, for example, are capable of forming salts in which the hydrogen of the —SO₂—NH— group is replaced by an agriculturally suitable cation. These salts are, for example, metal salts, in particular alkali metal salts or alkaline earth metal salts, in particular sodium salts and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃.

A) Preferred ALS inhibitors originate from the group of the sulfonylureas and/or salts thereof, for example pyrimidinyl- or triazolylaminocarbonyl[benzene-, -pyridine-, -pyrazole-, -thiophene- and -(alkylsulfonyl)alkylamino]sulfamides.

Such suitable sulfonylureas include, for example

A1) phenyl- and benzylsulfonylureas and related compounds, for example
1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenylsulfonyl)-3-(4,6-dimethylpyrimidin-2-yl)urea (sulfumeturon-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo-[b]thiophene-7-sulfonyl)urea (EP-A 0 079 683),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (iodosulfuron-methyl and its sodium salt, WO 92/13845),
DPX-66037, triflusulfuron-methyl (see Brighton Crop Prot. Conf. —Weeds—1995, p. 853),
CGA-277476, (see Brighton Crop Prot. Conf. —Weeds—1995, p. 79),
methyl 2-[3-(4,6-dimethoxypyrimidin-2-yl)ureidosulfonyl]-4-methanesulfonamidomethylbenzoate (mesosulfuron-methyl, WO 95/10507),
N,N-dimethyl-2-[3-(4,6-dimethoxypyrimidin-2-yl)ureidosulfonyl]-4-formylaminobenzamide (foramsulfuron, WO 95/01344);
   A2) thienylsulfonylureas, for example
1-(2-methoxycarbonylthiophen-3-yl)-3-(4-methoxy-6-methyl-1,3,5-triazin-2-yl)urea (thifensulfuron-methyl);
   A3) pyrazolylsulfonylureas, for example
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methylpyrazole-4-carboxylate (EP-A 0 282 613);
methyl 5-(4,6-dimethylpyrimidin-2-ylcarbamoylsulfamoyl)-1-(2-pyridyl)pyrazole-4-carboxylate (NC-330, see Brighton Crop Prot. Conference ‘Weeds’ 1991, Vol. 1, p. 45 ff.),
DPX-A8947, azimsulfuron, (see Brighton Crop Prot. Conf. ‘Weeds’ 1995, p. 65);
   A4) sulfonediamide derivatives, for example
3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));
   A5) pyridylsulfonylureas, for example
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, see Brighton Crop Prot. Conf. Weeds, 1995, p. 49),
pyridylsulfonylureas as described, for example, in DE-A 40 00 503 and DE-A 40 30 577, preferably those of the formula

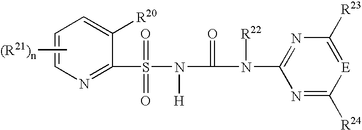

in which
E is CH or N, preferably CH,
R²⁰ is iodine or NR²⁵R²⁶,
R²¹ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxy-carbonyl, mono- or di-((C₁-C₃)-alkyl)amino, (C₁-C₃)-alkylsulfinyl or -sulfonyl, SO₂—NR^{x}R^{y} or CO—NR^{x}R^{y}, in particular hydrogen,
R^{x}, R^{y} independently of one another are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,
n is 0, 1, 2 or 3, preferably 0 or 1,
R²² is hydrogen or CH₃,
R²³ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,
R²⁴ is (C₁-C₂)-alkyl, (C₁-C₂)-haloalkoxy, preferably OCHF₂, or (C₁-C₂)-alkoxy,
R²⁵ is (C₁-C₄)-alkyl,
R²⁶ is (C₁-C₄)-alkylsulfonyl or
R²⁵ and R²⁶ together are a chain of the formula —(CH₂)₃SO₂— or —(CH₂)₄SO₂—, for example 3-(4,6-dimethoxypyrimidin-2-yl)-1-(3-N-methylsulfonyl-N-methylaminopyridin-2-yl)sulfonylurea, or salts thereof;

In a preferred embodiment of the oil suspension concentrate according to the invention, as herbicidally active compound, pyridylsulfonylurea is present in suspended form in the organic phase. This means that the main amount (in % by weight) of pyridylsulfonylurea is present undissolved in finely distributed form, a smaller amount of the pyridylsulfonylurea may be present in dissolved form. Preferably, the pyridylsulfonylurea is suspended in the organic solvent to more than 50% by weight, particularly preferably to more than 80% by weight, in each case based on the total amount of pyridylsulfonylurea a) in the oil suspension concentrate according to the invention.

A6) Preferred pyridylsulfonylureas are dioxazinepyridylsulfonylureas, in particular of the general formula (I)

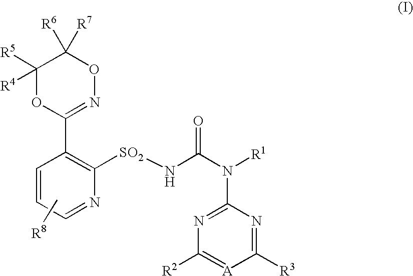

in which
A is nitrogen or a CR¹¹ grouping,
   where
   R¹¹ is hydrogen, alkyl, halogen or haloalkyl,
R¹ is hydrogen or an optionally substituted radical from the group consisting of alkyl, alkoxy, alkoxyalkyl, alkenyl, alkynyl, cycloalkyl, cycloalkylalkyl, aralkyl and aryl,
R² is hydrogen, halogen or is in each case optionally halogen-substituted alkyl, alkoxy, alkylthio, alkylamino or dialkylamino having in each case 1 to 6 carbon atoms,
R³ is hydrogen, halogen or is in each case optionally halogen-substituted alkyl, alkoxy, alkylthio, alkylamino or dialkylamino having in each case 1 to 6 carbon atoms,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl, alkylaminocarbonyl having in each case 1 to 3 carbon atoms,
   where in the radicals mentioned above the alkyl and alkylene groups may each contain 1 to 6 carbon atoms, the alkenyl and alkynyl groups may each contain 2 to 6 carbon atoms, the cycloalkyl groups may each contain 3 to 6 carbon atoms and the aryl groups may each contain 6 or 10 carbon atoms.

The compounds of the formula (I) and salts thereof are known, as is their preparation, for example from U.S. Pat. No. 5,476,936, the contents of which is part of the present description by way of reference.

Preference is given to compounds of the formula (I) and/or salts thereof

in which
A is nitrogen or a CH grouping,
R¹ is hydrogen or an optionally halogen-substituted radical from the group consisting of alkyl, alkoxy, alkoxyalkyl, alkenyl and alkynyl having in each case up to 3 carbon atoms,
R² is hydrogen, halogen or is in each case optionally halogen-substituted alkyl, alkoxy, alkylthio, alkylamino or dialkylamino having in each case 1 to 3 carbon atoms in the alkyl radicals,
R³ is hydrogen, halogen or is in each case optionally halogen-substituted alkyl, alkoxy, alkylthio, alkylamino or dialkylamino having in each case 1 to 3 carbon atoms in the alkyl radicals,
R⁴-R⁷ independently of one another are hydrogen, halogen, cyano, thiocyanato or are in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals,
R⁸ is hydrogen, halogen, cyano, thiocyanato or is in each case optionally halogen-substituted alkyl, alkoxy, alkylthio, alkylsulfinyl, alkylsulfonyl, alkylamino, alkylcarbonyl, alkoxycarbonyl or alkylaminocarbonyl having in each case 1 to 3 carbon atoms in the alkyl radicals.

Preference is furthermore given to salts obtained by customary processes from compounds of the formula (I) and bases, such as, for example, sodium hydroxide, potassium hydroxide or calcium hydroxide, sodium hydride, potassium hydride or calcium hydride, sodium amide, potassium amide or calcium amide and sodium carbonate, potassium carbonate or calcium carbonate, sodium C₁-C₄-alkoxides or potassium C₁-C₄-alkoxides, ammonia, C₁-C₄-alkylamines, di-(C₁-C₄-alkyl)amines or tri-(C₁-C₄-alkyl)amines.

Specially preferred include compounds of the formula (I) and/or salts thereof,

in which
A is nitrogen or a CH grouping,
R¹ is hydrogen, methyl, ethyl, methoxy, methoxymethyl or ethoxy,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ independently of one another are hydrogen, fluorine, chlorine, cyano, or are in each case optionally chlorine- or fluorine-substituted methyl, methylthio, methylsulfinyl, methylsulfonyl, methoxycarbonyl or ethoxycarbonyl, preferably hydrogen,
R⁸ is hydrogen, fluorine, chlorine, bromine, cyano or is in each case optionally chlorine- or fluorine-substituted methyl, methoxy, ethoxy, methylthio, ethylthio, methylsulfinyl, ethylsulfinyl, methylsulfonyl, ethylsulfonyl, methyl- or dimethylamino, preferably hydrogen.

Particular preference is given to compounds of the formula (I) and/or salts thereof, in particular their alkali metal salts,

in which
A is nitrogen,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

Particular preference is also given to compounds of the formula (I) and/or salts thereof, in particular their alkali metal salts,

in which
A is a CH grouping,
R¹ is hydrogen or methyl,
R² is hydrogen, chlorine, methyl, ethyl, trifluoromethyl, methoxy, ethoxy, difluoromethoxy, methylthio, methylamino or dimethylamino,
R³ is hydrogen, chlorine, methyl, ethyl, trifluoromethyl, methoxy, ethoxy, difluoromethoxy, methylthio, methylamino or dimethylamino,
R⁴-R⁷ are hydrogen,
R⁸ is hydrogen.

The general or preferred radical definitions given above can be combined with one another as desired, i.e. including combinations between the given preferred ranges.

The hydrocarbon radicals mentioned in the radical definitions, such as alkyl, alkenyl or alkynyl, can be straight-chain or branched even if this is not explicitly stated, including in combination with heteroatoms, such as in alkoxy, alkylthio, haloalkyl or alkylamino.

The pyridylsulfonylureas, for example those of the formula (I), can also be present as salts, for example as metal salts, such as alkali metal (for example Na, K) salts or as alkaline earth metal (for example Ca, Mg) salts or as ammonium salts or organic amine salts. Such salts are obtained in a simple manner by customary methods for forming salts, for example by dissolving or dispersing a pyridylsulfonylurea, for example of the formula (I), in a suitable diluent, such as, for example, methylene chloride, acetone, tert-butyl methyl ether or toluene, and adding a suitable base. The salts can then—if appropriate after prolonged stirring—be isolated by concentration or filtration with suction.

Herbicidally active compounds a) that are suitable according to the invention include those listed in table 1 below, where the following abbreviations are used:

TABLE 1
Examples of compounds of the formula (I) where
R⁴ = R⁵ = R⁶ = R⁷ = R⁸ = H:

| Ex. | | | | | m.p. |
|---|---|---|---|---|---|
| No. | R¹ | A | R² | R³ | (° C.) |
| I-1 | H | CH | OCH₃ | OC₂H₅ | 154 |
| I-2 | H | CH | OCH₃ | CH₃ | |
| I-3 | H | CH | OCH₃ | CH₃ | 180-181⁽⁺⁾ |
| I-4 | H | CH | OCH₃ | C₂H₅ | |
| I-5 | H | CH | OCH₃ | CF₃ | |
| I-6 | H | CH | OCH₃ | OCF₂H | |
| I-7 | H | CH | OCH₃ | NHCH₃ | |
| I-8 | H | CH | OCH₃ | N(CH₃)₂ | 199.5 |
| I-9 | H | CH | OCH₃ | Cl | 110-111 |
| I-10 | H | CH | OCH₃ | Cl | 175-178⁽⁺⁾ |
| I-11 | H | CH | OCH₃ | OCH₃ | 167-168 |
| I-12 | H | CH | OCH₃ | OCH₃ | 171-172⁽⁺⁾ |
| I-13 | H | CH | OC₂H₅ | OC₂H₅ | |
| I-14 | H | CH | OC₂H₅ | OC₂H₅ | 152-154⁽⁺⁾ |
| I-15 | H | CH | OC₂H₅ | CH₃ | |
| I-16 | H | CH | OC₂H₅ | C₂H₅ | |
| I-17 | H | CH | OC₂H₅ | CF₃ | |
| I-18 | H | CH | OC₂H₅ | OCF₂H | |
| I-19 | H | CH | OC₂H₅ | NHCH₃ | |
| I-20 | H | CH | OC₂H₅ | N(CH₃)₂ | |
| I-21 | H | CH | OC₂H₅ | Cl | 158-159 |
| I-22 | H | CH | OC₂H₅ | Cl | 213⁽⁺⁾ |
| I-23 | H | CH | CH₃ | CH₃ | 153 |
| I-24 | H | CH | CH₃ | C₂H₅ | |
| I-25 | H | CH | CH₃ | CF₃ | |
| I-26 | H | CH | CH₃ | OCF₂H | |
| I-27 | H | CH | CH₃ | NHCH₃ | |
| I-28 | H | CH | CH₃ | N(CH₃)2 | |
| I-29 | H | CH | CH₃ | Cl | 108-109 |
| I-30 | H | CH | CH₃ | Cl | >300⁽⁺⁾ |
| I-31 | H | CH | C₂H₅ | C₂H₅ | |
| I-32 | H | CH | C₂H₅ | CF₃ | |
| I-33 | H | CH | C₂H₅ | OCF₂H | |
| I-34 | H | CH | C₂H₅ | NHCH₃ | |
| I-35 | H | CH | C₂H₅ | Cl | |
| I-36 | H | CH | CF₃ | CF₃ | |
| I-37 | H | CH | CF₃ | OCF₂H | |
| I-38 | H | CH | CF₃ | NHCH₃ | |
| I-39 | H | CH | CF₃ | N(CH₃)₂ | |
| I-40 | H | CH | CF₃ | Cl | |
| I-41 | H | CH | OCF₂H | OCF₂H | |
| I-42 | H | CH | OCF₂H | NHCH₃ | |
| I-43 | H | CH | OCF₂H | N(CH₃)₂ | |
| I-44 | H | CH | OCF₂H | Cl | |
| I-45 | H | CH | NHCH₃ | NHCH₃ | |
| I-46 | H | CH | NHCH₃ | N(CH₃)₂ | |
| I-47 | H | CH | NHCH₃ | Cl | |
| I-48 | H | CH | N(CH₃)₂ | N(CH₃)₂ | |
| I-49 | H | CH | N(CH₃)₂ | Cl | |
| I-50 | H | CH | Cl | Cl | |
| I-51 | H | N | OCH₃ | OCH₃ | 255 |
| I-52 | H | N | OCH₃ | OCH₃ | 159-162⁽⁺⁾ |
| I-53 | H | N | OCH₃ | OC₂H₅ | |
| I-54 | H | N | OCH₃ | CH₃ | |
| I-55 | H | N | OCH₃ | C₂H₅ | |
| I-56 | H | N | OCH₃ | CF₃ | |
| I-57 | H | N | OCH₃ | OCF₂H | |
| I-58 | H | N | OCH₃ | NHCH₃ | |
| I-59 | H | N | OCH₃ | N(CH₃)₂ | |
| I-60 | H | N | OCH₃ | N(CH₃)₂ | 156⁽⁺⁾ |
| I-61 | H | N | OCH₃ | Cl | |
| I-62 | H | N | OC₂H₅ | OC₂H₅ | |
| I-63 | H | N | OC₂H₅ | CH₃ | |
| I-64 | H | N | OC₂H₅ | C₂H₅ | |
| I-65 | H | N | OC₂H₅ | CF₃ | |
| I-66 | H | N | OC₂H₅ | OCF₂H | |
| I-67 | H | N | OC₂H₅ | NHCH₃ | |
| I-68 | H | N | OC₂H₅ | N(CH₃)₂ | |
| I-69 | H | N | OC₂H₅ | Cl | |
| I-70 | H | N | OC₂H₅ | Cl | 213⁽⁺⁾ |
| I-71 | H | N | CH₃ | CH₃ | |
| I-72 | H | N | CH₃ | C₂H₅ | |
| I-73 | H | N | CH₃ | CF₃ | |
| I-74 | H | N | CH₃ | OCF₂H | |
| I-75 | H | N | CH₃ | NHCH₃ | |
| I-76 | H | N | CH₃ | N(CH₃)₂ | |
| I-77 | H | N | CH₃ | Cl | |
| I-78 | H | N | C₂H₅ | C₂H₅ | |
| I-79 | H | N | C₂H₅ | CF₃ | |
| I-80 | H | N | C₂H₅ | OCF₂H | |
| I-81 | H | N | C₂H₅ | NHCH₃ | |
| I-82 | H | N | C₂H₅ | Cl | |
| I-83 | H | N | CF₃ | CF₃ | |
| I-84 | H | N | CF₃ | OCF₂H | |
| I-85 | H | N | CF₃ | NHCH₃ | |
| I-86 | H | N | CF₃ | N(CH₃)₂ | |
| I-87 | H | N | CF₃ | Cl | |
| I-88 | H | N | OCF₂H | OCF₂H | |
| I-89 | H | N | OCF₂H | NHCH₃ | |
| I-90 | H | N | OCF₂H | N(CH₃)₂ | |
| I-91 | H | N | OCF₂H | Cl | |
| I-92 | H | N | NHCH₃ | NHCH₃ | |
| I-93 | H | N | NHCH₃ | N(CH₃)₂ | |
| I-94 | H | N | NHCH₃ | Cl | |
| I-95 | H | N | N(CH₃)₂ | N(CH₃)₂ | |
| I-96 | H | N | N(CH₃)₂ | Cl | |
| I-97 | H | N | Cl | Cl | |
| I-98 | CH₃ | N | OCH₃ | OCH₃ | |
| I-99 | CH₃ | N | OCH₃ | OC₂H₅ | |
| I-100 | CH₃ | N | OCH₃ | CH₃ | |
| I-101 | CH₃ | N | OCH₃ | C₂H₅ | |
| I-102 | CH₃ | N | OCH₃ | CF₃ | |
| I-103 | CH₃ | N | OCH₃ | OCF₂H | |
| I-104 | CH₃ | N | OCH₃ | NHCH₃ | |
| I-105 | CH₃ | N | OCH₃ | N(CH₃)₂ | |
| I-106 | CH₃ | N | OCH₃ | Cl | |
| I-107 | CH₃ | N | OC₂H₅ | OC₂H₅ | |
| I-108 | CH₃ | N | OC₂H₅ | CH₃ | |
| I-109 | CH₃ | N | OC₂H₅ | C₂H₅ | |
| I-110 | CH₃ | N | OC₂H₅ | CF₃ | |
| I-111 | CH₃ | N | OC₂H₅ | OCF₂H | |
| I-112 | CH₃ | N | OC₂H₅ | NHCH₃ | |
| I-113 | CH₃ | N | OC₂H₅ | N(CH₃)₂ | |
| I-114 | CH₃ | N | OC₂H₅ | Cl | |
| I-115 | CH₃ | N | CH₃ | CH₃ | |
| I-116 | CH₃ | N | CH₃ | C₂H₅ | |
| I-117 | CH₃ | N | CH₃ | CF₃ | |
| I-118 | CH₃ | N | CH₃ | OCF₂H | |
| I-119 | CH₃ | N | CH₃ | NHCH₃ | |
| I-120 | CH₃ | N | CH₃ | N(CH₃)₂ | |
| I-121 | CH₃ | N | CH₃ | Cl | |
| I-122 | CH₃ | N | C₂H₅ | C₂H₅ | |
| I-123 | CH₃ | N | C₂H₅ | CF₃ | |
| I-124 | CH₃ | N | C₂H₅ | OCF₂H | |
| I-125 | CH₃ | N | C₂H₅ | NHCH₃ | |
| I-126 | CH₃ | N | C₂H₅ | Cl | |
| I-127 | CH₃ | N | CF₃ | CF₃ | |
| I-128 | CH₃ | N | CF₃ | OCF₂H | |
| I-129 | CH₃ | N | CF₃ | NHCH₃ | |
| I-130 | CH₃ | N | CF₃ | N(CH₃)₂ | |
| I-131 | CH₃ | N | CF₃ | Cl | |
| I-132 | CH₃ | N | OCF₂H | OCF₂H | |
| I-133 | CH₃ | N | OCF₂H | NHCH₃ | |
| I-134 | CH₃ | N | OCF₂H | N(CH₃)₂ | |
| I-135 | CH₃ | N | OCF₂H | Cl | |
| I-136 | CH₃ | N | NHCH₃ | NHCH₃ | |
| I-137 | CH₃ | N | NHCH₃ | N(CH₃)₂ | |
| I-138 | CH₃ | N | NHCH₃ | Cl | |
| I-139 | CH₃ | N | N(CH₃)₂ | N(CH₃)₂ | |
| I-140 | CH₃ | N | N(CH₃)₂ | Cl | |
| I-141 | CH₃ | N | Cl | Cl | |
| I-142 | H | N | N(CH₃)₂ | OCH₂CF₃ | 158 |
| I-143 | H | CH | Cl | OCH₂CF₃ | 204-205 |
| I-144 | H | CH | Cl | OCH₂CF₃ | |
| I-145 | H | CH | Cl | OCH₂CF₃ | 207⁽⁺⁾ |

In some embodiments, the melting point of the sodium salt of active compound (a) is advantageously at least 120 C. In the oil suspension concentrates according to the invention, the herbicidally active compounds from the group of the pyridylsulfonylureas are generally present in amounts of from 0.01 to 50% by weight, preferably from 0.1 to 30% by weight; here and in the entire description, unless defined otherwise, the statement “% by weight” refers to the relative weight of the component in question, based on the total weight of the formulation.

A7) Alkoxyphenoxysulfonylureas as described, for example, in EP-A 0 342 569, preferably those of the formula

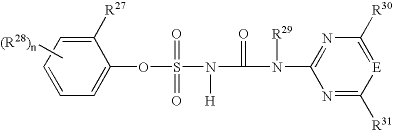

in which
E is CH or N, preferably CH,
R²⁷ is ethoxy, propoxy or isopropoxy,
R²⁸ is halogen, NO₂, CF₃, CN, (C₁-C₄)-alkyl, (C₁-C₄)-alkoxy, (C₁-C₄)-alkylthio or (C₁-C₃)-alkoxy-carbonyl, preferably in the 6-position on the phenyl ring,
n is 0, 1, 2 or 3, preferably 0 or 1,
R²⁹ is hydrogen, (C₁-C₄)-alkyl or (C₃-C₄)-alkenyl,
R³⁰, R³¹ independently of one another are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, for example 3-(4,6-dimethoxypyrimidin-2-yl)-1-(2-ethoxyphenoxy)sulfonylurea, or salts thereof;
   A8) Imidazolylsulfonylureas, for example
MON 37500, sulfosulfuron (see Brighton Crop Prot. Conf. ‘Weeds’, 1995, p. 57), and other related sulfonylurea derivatives and mixtures thereof.

Typical representatives of these active compounds are inter alia the compounds listed below: amidosulfuron, azimsulfuron, bensulfuron-methyl, chlorimuron-ethyl, chlorsulfuron, cinosulfuron, cyclosulfamuron, ethametsulfuron-methyl, ethyoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 2000)).

### A9) Phenylsulfonylaminocarbonyltriazolinones

Examples of compounds from the group of the phenylsulfonylaminocarbonyl-triazolinones are, for example, flucarbazone or propoxycarbazone and/or salts thereof.

### A10) (Het)arylsulfonylaminocarbonyltriazolinones

Thien-3-ylsulfonylamino(thio)carbonyltriazolin(ethi)one of the general formula (II)

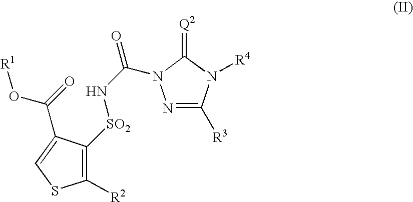

in which
Q¹ is O (oxygen) or S (sulfur),
Q² is O (oxygen) or S (sulfur),
R¹ is optionally cyano-, halogen- or C₁-C₄-alkoxy-substituted alkyl having 1 to 6 carbon atoms, is in each case optionally cyano- or halogen-substituted alkenyl or alkynyl having in each case 2 to 6 carbon atoms, is in each case optionally cyano-, halogen- or C₁-C₄-alkyl-substituted cycloalkyl or cycloalkylalkyl having in each case 3 to 6 carbon atoms in the cycloalkyl group and, if appropriate, 1 to 4 carbon atoms in the alkyl moiety, is in each case optionally nitro-, cyano-, halogen-, C₁-C₄-alkyl or C₁-C₄-alkoxy-substituted aryl or arylalkyl having in each case 6 or 10 carbon atoms in the aryl group and, if appropriate, 1 to 4 carbon atoms in the alkyl moiety, or is in each case optionally nitro-, cyano-, halogen-, C₁-C₄-alkyl- or C₁-C₄-alkoxy-substituted heterocyclyl or heterocyclylalkyl having in each case up to 6 carbon atoms and additionally 1 to 4 nitrogen atoms and/or 1 to 2 oxygen or sulfur atoms in the heterocyclyl group and, if appropriate, 1 to 4 carbon atoms in the alkyl moiety,
R² is hydrogen, C₁-C₄-alkyl, cyano, nitro, halogen, is in each case optionally cyano-, halogen- or C₁-C₄-alkoxy-substituted alkyl, alkoxy, alkoxycarbonyl, alkylthio, alkylsulfinyl or alkylsulfonyl having in each case 1 to 6 carbon atoms in the alkyl group, or is in each case optionally cyano- or halogen-substituted alkenyl, alkynyl, alkenyloxy or alkynyloxy having in each case 2 to 6 carbon atoms in the alkenyl or alkynyl group,
R³ is hydrogen, hydroxy, mercapto, amino, cyano, fluorine, chlorine, bromine, iodine, is optionally fluorine-, chlorine-, bromine-, cyano-, C₁-C₄-alkoxy-, C₁-C₄-alkylcarbonyl- or C₁-C₄-alkoxy-carbonyl-substituted alkyl having 1 to 6 carbon atoms, is in each case optionally fluorine-, chlorine- and/or bromine-substituted alkenyl or alkynyl having in each case 2 to 6 carbon atoms, is in each case optionally fluorine-, chlorine-, cyano-, C₁-C₄-alkoxy- or C₁-C₄-alkoxy-carbonyl-substituted alkoxy, alkylthio, alkylamino or alkylcarbonylamino having in each case 1 to 6 carbon atoms in the alkyl group, is alkenyloxy, alkynyloxy, alkenylthio, alkynylthio, alkenylamino or alkynylamino having in each case 3 to 6 carbon atoms in the alkenyl or alkynyl group, is dialkylamino having in each case 1 to 4 carbon atoms in the alkyl groups, is in each case optionally methyl- and/or ethyl-substituted aziridino, pyrrolidino, piperidino or morpholino, is in each case optionally fluorine-, chlorine-, bromine-, cyano- and/or C₁-C₄-alkyl-substituted cycloalkyl, cycloalkenyl, cycloalkyloxy, cycloalkylthio, cycloalkylamino, cycloalkylalkyl, cycloalkylalkoxy, cycloalkyl-alkylthio or cycloalkylalkylamino having in each case 3 to 6 carbon atoms in the cycloalkyl or cycloalkenyl group and, if appropriate, 1 to 4 carbon atoms in the alkyl moiety, or is in each case optionally fluorine-, chlorine-, bromine-, cyano-, nitro-, C₁-C₄-alkyl-1 trifluoromethyl-, C₁-C₄-alkoxy- and/or C₁-C₄-alkoxycarbonyl-substituted aryl, arylalkyl, aryloxy, arylalkoxy, arylthio, arylalkylthio, arylamino or arylalkylamino having in each case 6 or 10 carbon atoms in the aryl group and, if appropriate, 1 to 4 carbon atoms in the alkyl moiety,
R⁴ is hydrogen, C₁-C₄-alkyl, hydroxyl, amino, cyano, is C₂-C₁₀-alkylideneamino, is optionally fluorine-, chlorine-, bromine-, cyano-, C₁-C₄-alkoxy-, C₁-C₄-alkylcarbonyl- or C₁-C₄-alkoxy-carbonyl-substituted alkyl having 1 to 6 carbon atoms, is in each case optionally fluorine-, chlorine- and/or bromine-substituted alkenyl or alkynyl having in each case 2 to 6 carbon atoms, is in each case optionally fluorine-, chlorine-, bromine-, cyano-, C₁-C₄-alkoxy- or C₁-C₄-alkoxy-carbonyl-substituted alkoxy, alkylamino or alkylcarbonylamino having in each case 1 to 6 carbon atoms in the alkyl group, is alkenyloxy having 3 to 6 carbon atoms, is dialkylamino having in each case 1 to 4 carbon atoms in the alkyl groups, is in each case optionally fluorine-, chlorine-, bromine-, cyano- and/or C₁-C₄-alkyl-substituted cycloalkyl, cycloalkylamino or cycloalkylalkyl having in each case 3 to 6 carbon atoms in the alkyl group and, if appropriate, 1 to 4 carbon atoms in alkyl moiety, or is in each case optionally fluorine-, chlorine-, bromine-, cyano-, nitro-, C₁-C₄-alkyl-, trifluoromethyl- and/or C₁-C₄-alkoxy-substituted aryl or arylalkyl having in each case 6 or 10 carbon atoms in the aryl group and, if appropriate, 1 to 4 carbon atoms in the alkyl moiety, or
R³ and R⁴ together are optionally branched alkanediyl having 3 to 6 carbon atoms,
   —and also salts of the compounds of the formula (II)—

| | |
|---|---|
| | (II) |
| 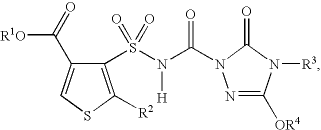 | |

| No. | R¹ | R² | R³ | R⁴ |
|---|---|---|---|---|
| A1 | ethyl | ethyl | ethyl | ethyl |
| A2 | ethyl | ethyl | ethyl | methyl |
| A3 | ethyl | ethyl | methyl | ethyl |
| A4 | ethyl | methyl | ethyl | ethyl |
| A5 | methyl | ethyl | ethyl | ethyl |
| A6 | ethyl | ethyl | methyl | methyl |
| A7 | methyl | ethyl | ethyl | methyl |
| A8 | methyl | methyl | ethyl | ethyl |
| A9 | ethyl | methyl | ethyl | methyl |
| A10 | methyl | ethyl | methyl | ethyl |
| A11 | ethyl | methyl | methyl | ethyl |
| A12 | methyl | methyl | methyl | methyl |
| A13 | methyl | methyl | methyl | ethyl |
| A14 | methyl | methyl | ethyl | methyl |
| A15 | methyl | ethyl | methyl | methyl |
| A16 | ethyl | methyl | methyl | methyl |

B) herbicides of the type of the phenoxyphenoxy- and heteroaryloxyphenoxycarboxylic acid derivatives, such as
B1) phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat. No. 4,808,750), methyl 2-(4-(2-chloro-4-trifluoromethylphenoxy)phenoxy)propionate (DE-A 24 33 067), methyl 2-(4-(2-fluoro-4-trifluoromethylphenoxy)phenoxy)propionate (U.S. Pat. No. 4,808,750), methyl 2-(4-(2,4-dichlorobenzyl)phenoxy)propionate (DE-A 24 17 487), ethyl 4-(4-(4-trifluoromethylphenoxy)phenoxy)pent-2-enoate, methyl 2-(4-(4-trifluoromethylphenoxy)phenoxy)propionate (DE-A 24 33 067);
B2) “mononuclear” heteroaryloxyphenoxyalkanecarboxylic acid derivatives, for example
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736),
butyl 2-(4-(5-trifluoromethyl-2-pyridyloxy)phenoxy)propionate (fluazifop-butyl);
   B3) “binuclear” heteroaryloxyphenoxyalkanecarboxylic acid derivatives, for example
methyl and ethyl 2-(4-(6-chloro-2-quinoxalyloxy)phenoxy)propionate (quizalofop-methyl and quizalofop-ethyl),
methyl 2-(4-(6-fluoro-2-quinoxalyloxy)phenoxy)propionate (see J. Pest. Sci., Vol. 10, 61 (1985)),
2-isopropylideneaminooxyethyl 2-(4-(6-chloro-2-quinoxalyloxy)phenoxy)propionate (propaquizafop),
ethyl 2-(4-(6-chlorobenzoxazol-2-yloxy)phenoxy)propionate (fenoxaprop-ethyl), the D(+) isomer thereof (fenoxaprop-P-ethyl) and ethyl 2-(4-(6-chlorobenzothiazol-2-yloxy)phenoxy)propionate (DE-A 26 40 730),
tetrahydrofur-2-ylmethyl 2-(4-(6-chloroquinoxalyloxy)phenoxy)propionate (EP-A 0 323 727);
   C) chloroacetanilides, for example
N-methoxymethyl-2,6-diethylchloroacetanilide (alachlor),
N-(3-methoxyprop-2-yl)-2-methyl-6-ethylchloroacetanilide (metolachlor),
N-(3-methyl-1,2,4-oxadiazol-5-ylmethyl)chloroacetic acid 2,6-dimethylanilide,
N-(2,6-dimethylphenyl)-N-(1-pyrazolylmethyl)chloroacetamide (metazachlor);
   D) thiocarbamates, for example
S-ethyl N,N-dipropylthiocarbamate (EPTC),
S-ethyl N,N-diisobutylthiocarbamate (butylate);
   E) cyclohexanedione oximes, for example
methyl 3-(1-allyloxyiminobutyl)-4-hydroxy-6,6-dimethyl-2-oxocyclohex-3-enecarboxylate, (alloxydim),
2-(1-ethoxyiminobutyl)-5-(2-ethylthiopropyl)-3-hydroxycyclohex-2-en-1-one (sethoxydim),
2-(1-ethoxyiminobutyl)-5-(2-phenylthiopropyl)-3-hydroxycyclohex-2-en-1-one (cloproxydim),
2-(1-(3-chloroallyloxyimino)butyl)-5-(2-ethylthiopropyl)-3-hydroxycyclohex-2-en-1-one,
2-(1-(3-chloroallyloxyimino)propyl)-5-(2-ethylthiopropyl)-3-hydroxycyclohex-2-en-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-en-1-one (tralkoxydim);
   F) imidazolinones, for example
methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz),
5-ethyl-2-(4-isopropyl-4-methyl-5-oxo-2-imidazolin-2-yl)pyridine-3-carboxylic acid (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);
   G) triazolopyrimidinesulfonamide derivatives, for example
N-(2,6-difluorophenyl)-7-methyl-1,2,4-triazolo[1,5-c]pyrimidine-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);
   H) benzoylcyclohexanediones, for example
2-(2-chloro-4-methylsulfonylbenzoyl)cyclohexane-1,3-dione (SC-0051, EP-A 0 137 963), 2-(2-nitrobenzoyl)-4,4-dimethylcyclohexane-1,3-dione (EP-A 0 274 634),
2-(2-nitro-3-methylsulfonylbenzoyl)-4,4-dimethylcyclohexane-1,3-dione (WO 91/13548);
   I) pyrimidinyloxypyridinecarboxylic acid or pyrimidinyloxybenzoic acid derivatives, for example
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-dimethoxypyrimidin-2-yl)oxy]benzoate (EP-A 0 472 113);
   J) S-(N-aryl-N-alkylcarbamoylmethyl)dithiophosphoric esters, such as S-[N-(4-chlorophenyl)-N-isopropylcarbamoylmethyl]O,O-dimethyl dithiophosphate (anilophos);
   K) 2,4-diamino-s-triazines, preferably alkylazines,

Preference is also given to salts, preferably acid addition salts of the compounds, for example their hydrochlorides.

L) Phosphorus-herbicides, for example one or more compounds of the formula (IV) or derivatives thereof, such as salts,

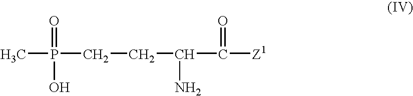

in which
Z¹ is a radical of the formula —OM, —NHCH(CH₃)CONHCH(CH₃)CO₂M or —NHCH(CH₃)CONHCH[CH₂CH(CH₃)₂]CO₂M and
M=H or a salt-forming cation,
and/or one or more compounds of the formula (V) or derivatives thereof, such as salts,

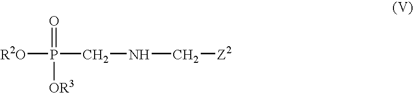

in which
Z² is a radical of the formula CN or CO₂R¹ in which R¹=Q or a salt-forming cation, where Q=H, alkyl, alkenyl, alkoxyalkyl or C₆-C₁₀-aryl which is unsubstituted or substituted and preferably unsubstituted or substituted by one or more radicals from the group consisting of alkyl, alkoxy, halogen, CF₃, NO₂ and CN, and
R²,R³ are each independently of one another H, alkyl, C₆-C₁₀-aryl which is unsubstituted or substituted and preferably unsubstituted or substituted by
   one or more radicals from the group consisting of alkyl, alkoxy, halogen, CF₃, NO₂ and CN, or biphenyl or a salt-forming cation.

Examples of active compounds of the formulae (IV) and (V) are those below
glufosinate and its ammonium salt in racemic form, i.e. 2-amino-4-[hydroxy(methyl)phosphinoyl]butanoic acid and its ammonium salt,
the L enantiomer of glufosinate and its ammonium salt,
bilanafos/bialaphos, i.e. L-2-amino-4-[hydroxy(methyl)phosphinoyl]butanoyl-L-alaninyl-L-alanine and its sodium salt
glyphosate.
   M) Carbamates, for example asulam, carbetamide, chloropham and propham;
   N) benzofurans, for example benfuresate and ethofumesate;
   O) phytohormones;
   P) auxins and auxin analogs, for example 4-indole-3-butyric acid, indole-3-acetic acid, 1-naphthylacetic acid, 2-(1-naphthyl)acetamide and 2-naphthyloxyacetic acid;
   Q) cytokinins, for example kinetin and 6-benzylaminopurine;
   R) gibberellins, for example gibberillic acid, gibberillin A4 and A7;
   S) abscissic acid and the derivatives thereof;
   T) ethylene precursors, for example ethephone;
   U) herbicides from the group of the fatty acid synthetase inhibitors;
   V) ureas, for example chlorotoluron, dimefuron, diuron, fluometuron, isoproturon, isouron, karbutilate, linuron, methabenzthiazuron, metobenzuron, metoxuron, monolinuron, neburon, siduron and tebuthiuron and
   W) metamitron;
   X) hydroxybenzonitriles, for example such as bromoxynil and ioxynil and the salts and esters thereof, such as bromoxynil octanoate and ioxynil octanoate.

The agrochemically active compounds may also be growth regulators. Examples of these include terbufos, cyclanilide and thidiazuron.

The herbicides (plant growth regulators) of groups A to X are known, for example, from the documents mentioned in each case above and/or from “The Pesticide Manual”, 12th edition (2000) and 13th edition (2003), The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA, 1990, each incorporated herein by reference.

### Safeners

The agrochemically active compounds may also be safeners. Examples of these include, inter alia:

a) compounds of the formulae (S-II) to (S-IV),

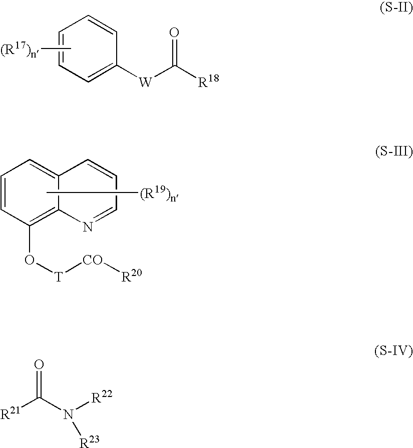

where the symbols and indices are as defined below:
n′ is a natural number from 0 to 5, preferably from 0 to 3;
T is a (C₁ or C₂)-alkanediyl chain which is unsubstituted or substituted by one or two (C₁-C₄)-alkyl radicals or by [(C₁-C₃)-alkoxy]carbonyl;
W is an unsubstituted or substituted divalent heterocyclic radical from the group of the partially unsaturated or aromatic five-membered heterocycles having 1 to 3 heteroring atoms of the type N or O, where the ring comprises at least one N-atom and at most one O-atom, preferably a radical from the group consisting of (W1) to (W4),

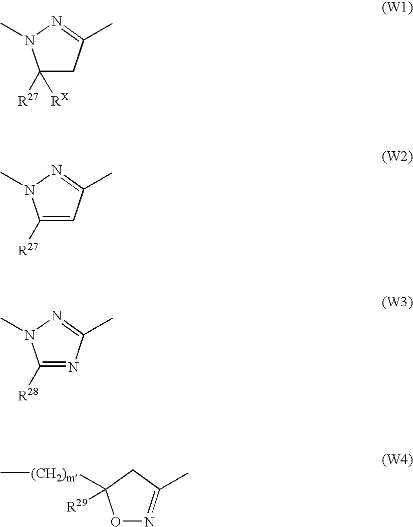

m′ is 0 or 1;
R¹⁷, R¹⁹ are identical or different and are halogen, (C₁-C₄)-alkyl, (C₁-C₄)-alkoxy, nitro or (C₁-C₄)-haloalkyl radicals;
R¹⁸, R²⁰ are identical or different OR²⁴, SR²⁴ or NR²⁴R²⁵ radicals or a saturated or unsaturated 3- to 7-membered heterocycle having at least one N-atom and up to 3 heteroatoms, preferably from the group consisting of O and S, which is attached via the N-atom to the carbonyl group in (S-II) or (S-III) and which is unsubstituted or substituted by radicals from the group consisting of (C₁-C₄)-alkyl, (C₁-C₄)-alkoxy and optionally substituted phenyl, preferably a radical of the formula OR²⁴, NHR²⁵ or N(CH₃)₂, in particular of the formula OR²⁴;
R²⁴ is hydrogen or an unsubstituted or substituted aliphatic hydrocarbon radical, preferably having a total of 1 to 18 carbon atoms;
R²⁵ is hydrogen, (C₁-C₆)-alkyl, (C₁-C₆)-alkoxy or substituted or unsubstituted phenyl;
R^{X} is H, (C₁-C₈)-alkyl, (C₁-C₈)-haloalkyl, (C₁-C₄)-alkoxy-(C₁-C₈)-alkyl, cyano or COOR²⁶ where R²⁶ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R²⁷, R²⁸, R²⁹ are identical or different and are hydrogen, (C₁-C₈)-alkyl, (C₁-C₈)-haloalkyl, (C₃-C₁₂)-cycloalkyl or substituted or unsubstituted phenyl;
R²¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R²², R²³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R²² and R²³ together form a substituted or unsubstituted heterocyclic ring,
   preferably an oxazolidine, thiazolidine, piperidine, morpholine, hexahydropyrimidine or benzoxazine ring;
      preferably safeners from the following subgroups of compounds of the formulae (S-II) to (S-IV):
   compounds of the type of the dichlorophenylpyrazoline-3-carboxylic acid (i.e. of the formula (S-II) in which W=(W1) and (R¹⁷)_{n′}=2,4-Cl₂), preferably compounds such as ethyl 1-(2,4-dichlorophenyl)-5-(ethoxycarbonyl)-5-methyl-2-pyrazoline-3-carboxylate (II-1, mefenpyr-diethyl), mefenpyr-dimethyl and mefenpyr (II-0), and related compounds, as described in WO-A-91/07874;
   derivatives of dichlorophenylpyrazolecarboxylic acid (i.e. of the formula (S-II) in which W=(W2) and (R¹⁷)_{n′}=2,4-Cl₂), preferably compounds such as ethyl 1-(2,4-dichlorophenyl)-5-methylpyrazole-3-carboxylate (II-2), ethyl 1-(2,4-dichlorophenyl)-5-isopropylpyrazole-3-carboxylate (II-3), ethyl 1-(2,4-dichlorophenyl)-5-(1,1-dimethylethyl)pyrazole-3-carboxylate (II-4), ethyl 1-(2,4-dichlorophenyl)-5-phenylpyrazole-3-carboxylate (II-5) and related compounds, as described in EP-A-0333131 and EP-A-0269806;
   compounds of the type of the triazolecarboxylic acids (i.e. of the formula (S-II) in which W=(W3) and (R¹⁷)_{n′}=2,4-Cl₂), preferably compounds such as fenchlorazole-ethyl, i.e. ethyl 1-(2,4-dichlorophenyl)-5-trichloromethyl-(1H)-1,2,4-triazole-3-carboxylate (II-6), and related compounds (see EP-A-0174562 and EP-A-0346620);
   compounds of the type of the 5-benzyl- or 5-phenyl-2-isoxazoline-3-carboxylic acid or the 5,5-diphenyl-2-isoxazoline-3-carboxylic acid, such as isoxadifen (II-12), (in which W=(W4)), preferably compounds such as ethyl 5-(2,4-dichloro-benzyl)-2-isoxazoline-3-carboxylate (II-7) or ethyl 5-phenyl-2-isoxazoline-3-carboxylate (II-8) and related compounds, as described in WO-A-91/08202, or ethyl 5,5-diphenyl-2-isoxazoline carboxylate (II-9, isoxadifen-ethyl) or n-propyl 5,5-diphenyl-2-isoxazoline carboxylate (II-10) or ethyl 5-(4-fluorophenyl)-5-phenyl-2-isoxazoline-3-carboxylate (II-11), as described in WO-A-95/07897.
   Compounds of the type of the 8-quinolineoxyacetic acid, for example those of the formula (S-III) in which (R¹⁹)_{n′}=5-Cl, R²⁰=OR²⁴ and T=CH₂, preferably the compounds 1-methylhexyl (5-chloro-8-quinolineoxy)acetate (III-1, cloquintocet-mexyl), 1,3-dimethylbut-1-yl (5-chloro-8-quinolineoxy)acetate (III-2), 4-allyloxybutyl(5-chloro-8-quinolineoxy)acetate (III-3), 1-allyloxyprop-2-yl (5-chloro-8-quinolineoxy)acetate (III-4), ethyl (5-chloro-8-quinolineoxy)acetate (III-5), methyl(5-chloro-8-quinolineoxy)acetate (III-6), allyl (5-chloro-8-quinolineoxy)acetate (III-7), 2-(2-propylideneiminoxy)-1-ethyl (5-chloro-8-quinolineoxy)acetate (III-8), 2-oxoprop-1-yl (5-chloro-8-quinolineoxy)acetate (III-9), (5-chloro-8-quinolineoxy)acetic acid (III-10) and its salts, as described, for example in WO-A-02/34048, and related compounds, as described in EP-A-0860750, EP-A-0094349 and EP-A-0191736 or EP-A-0492366.
   Compounds of the type of the (5-chloro-8-quinolineoxy)malonic acid, i.e. of the formula (S-III) in which (R¹⁹)_{n′}=5-Cl, R²⁰=OR²⁴, T=—CH(COO-alkyl)-, preferably the compounds diethyl (5-chloro-8-quinolineoxy)malonate (III-11), diallyl (5-chloro-8-quinolineoxy)malonate, methyl ethyl (5-chloro-8-quinolineoxy)malonate and related compounds, as described in EP-A-0582198.
   Compounds of the type of the dichloroacetamides, i.e. of the formula (S-IV), preferably: N,N-diallyl-2,2-dichloroacetamide (dichlormid (IV-1), from U.S. Pat. No. 4,137,070), 4-dichloroacetyl-3,4-dihydro-3-methyl-2H-1,4-benzoxazine (IV-2, benoxacor, from EP 0149974), N1,N2-diallyl-N2-dichloroacetylglycinamide (DKA-24 (IV-3), from HU 2143821), 4-dichloroacetyl-1-oxa-4-azaspiro[4,5]decane (AD-67), 2,2-dichloro-N-(1,3-dioxolan-2-ylmethyl)-N-(2-propenyl)acetamide (PPG-1292), 3-dichloroacetyl-2,2,5-trimethyloxazolidine (R-29148, IV-4), 3-dichloroacetyl-2,2-dimethyl-5-phenyloxazolidine, 3-dichloroacetyl-2,2-dimethyl-5-(2-thienyl)oxazolidine, 3-dichloroacetyl-5-(2-furanyl)-2,2-dimethyloxazolidine (furilazole (IV-5), MON 13900), 1-dichloroacetylhexahydro-3,3,8a-trimethylpyrrolo[1,2-a]pyrimidine-6(2H)-one (dicyclonon, BAS 145138),
      b) one or more compounds from the group consisting of:
      1,8-naphthalic anhydride, methyl diphenylmethoxyacetate, 1-(2-chlorobenzyl)-3-(1-methyl-1-phenylethyl)urea (cumyluron), O,O-diethyl S-2-ethylthioethyl phosphorodithioate (disulfoton), 4-chlorophenyl methylcarbamate (mephenate), O,O-diethyl O-phenyl phosphorothioate (dietholate), 4-carboxy-3,4-dihydro-2H-1-benzopyran-4-acetic acid (CL-304415, CAS-Regno: 31541-57-8), cyanomethoxyimino(phenyl)acetonitrile (cyometrinil), 1,3-dioxolan-2-ylmethoxyimino(phenyl)acetonitrile (oxabetrinil), 4′-chloro-2,2,2-trifluoroacetophenone O-1,3-dioxolan-2-ylmethyloxime (fluxofenim), 4,6-dichloro-2-phenylpyrimidine (fenclorim), benzyl 2-chloro-4-trifluoromethyl-1,3-thiazole-5-carboxylate (flurazole), 2-dichloromethyl-2-methyl-1,3-dioxolane (MG-191), N-(4-methylphenyl)-N′-(1-methyl-1-phenylethyl)urea (dymron), (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor) and their salts and esters, preferably (C₁-C₈);
      c) N-acylsulfonamides of the formula (S-V) and their salts,

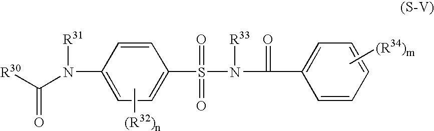

in which
R³⁰ is hydrogen, a hydrocarbon radical, a hydrocarbonoxy radical, a hydrocarbonthio radical or a heterocyclyl radical which is preferably attached via a C atom, where each of the 4 last-mentioned radicals is unsubstituted or substituted by one or more identical or different radicals from the group consisting of halogen, cyano, nitro, amino, hydroxyl, carboxyl, formyl, carbonamide, sulfonamide and radicals of the formula -Z^{a}-R^{a},
   where each hydrocarbon moiety has preferably 1 to 20 C-atoms and a C-containing radical R³⁰ including substituents has preferably 1 to 30 C-atoms;
R³¹ is hydrogen or (C₁-C₄)-alkyl, preferably hydrogen, or
R³⁰ and R³¹ together with the group of the formula —CO—N— are the radicals of a 3- to 8-membered saturated or unsaturated ring;
R³² are identical or different radicals from the group consisting of halogen, cyano, nitro, amino, hydroxyl, carboxyl, formyl, CONH₂, SO₂NH₂ or a radical of the formula -Z^{b}-R^{b};
R³³ is hydrogen or (C₁-C₄)-alkyl, preferably H;
R³⁴ are identical or different radicals from the group consisting of halogen, cyano, nitro, amino, hydroxyl, carboxyl, CHO, CONH₂, SO₂NH₂ and a radical of the formula -Z^{c}-R^{c};
R^{a} is a hydrocarbon radical or a heterocyclyl radical, where each of the two last-mentioned radicals is unsubstituted or substituted by one or more identical or different radicals from the group consisting of halogen, cyano, nitro, amino, hydroxyl, mono- and di-[(C₁-C₄)-alkyl]amino, or an alkyl radical in which a plurality, preferably 2 or 3, non-adjacent CH₂ groups are in each case replaced by an oxygen atom;
R^{b},R^{c} are identical or different and are a hydrocarbon radical or a heterocyclyl radical, where each of the two last-mentioned radicals is unsubstituted or substituted by one or more identical or different radicals from the group consisting of halogen, cyano, nitro, amino, hydroxyl, phosphoryl, halo-(C₁-C₄)-alkoxy, mono- and di-[(C₁-C₄)-alkyl]amino, or an alkyl radical in which a plurality, preferably 2 or 3, non-adjacent CH₂ groups are in each case replaced by an oxygen atom;
   Z^{a} is a divalent group of the formula —O—, —S—, —CO—, —CS—, —CO—O—, —CO—S—, O—CO—, —S—CO—, —SO—, —SO₂—, —NR*—, —CO—NR*—, —NR*—CO—, —SO₂—NR*— or —NR*—SO₂—, where the bond indicated on the right-hand side of the divalent group in question is the bond to the radical R^{a} and where the R* in the 5 last-mentioned radicals independently of one another are each H, (C₁-C₄)-alkyl or halo-(C₁-C₄)-alkyl;
Z^{b}, Z^{c} independently of one another are a direct bond or a divalent group of the formula —O—, —S—, —CO—, —CS—, —CO—O—, —CO—S—, —O—CO—, —S—CO—, —SO—, —SO₂—, —NR*—, —SO₂—NR*—, —NR*—SO₂—, —CO—NR*— or —NR*—CO—, where the bond indicated on the right-hand side of the divalent group in question is the bond to the radical R^{b} or R^{c} and where R* in the 5 last-mentioned radicals independently of one another are each H, (C₁-C₄)-alkyl or halo-(C₁-C₄)-alkyl;
n is an integer from 0 to 4, preferably 0, 1 or 2, particularly preferably 0 or 1, and
m is an integer from 0 to 5, preferably 0, 1, 2 or 3, in particular 0, 1 or 2;
   preferably safeners of compounds of the formula (S-V), in which
   R³⁰=H₃C—O—CH₂—, R³¹=R³³=H, R³⁴=2-Ome (V-1),
   R³⁰=H₃C—O—CH₂—, R³¹=R³³=H, R³⁴=2-Ome-5-Cl (V-2),
   R³⁰=cyclopropyl, R³¹=R³³=H, R³⁴=2-Ome (V-3),
   R³⁰=cyclopropyl, R³¹=R³³=H, R³⁴=2-Ome-5-Cl (V-4),
   R³⁰=cyclopropyl, R³¹=R³³=H, R³⁴=2-Ome (V-5),
   R³⁰=tert-butyl, R³¹=R³³=H, R³⁴=2-Ome (V-6).
      d) Acylsulfamoylbenzamides of the general formula (S-VI), if appropriate also in salt form,

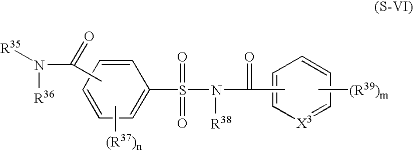

in which
X³ is CH or N;
R³⁵ is hydrogen, heterocyclyl or a hydrocarbon radical where the two last-mentioned radicals are optionally substituted by one or more identical or different radicals from the group consisting of halogen, cyano, nitro, amino, hydroxyl, carboxyl, CHO, CONH₂, SO₂NH₂ and Z^{a}-R^{a};
R³⁶ is hydrogen, hydroxyl, (C₁-C₆)-alkyl, (C₂-C₆)-alkenyl, (C₂-C₆)-alkynyl, (C₁-C₆)-alkoxy, (C₂-C₆)-alkenyloxy, where the five last-mentioned radicals are optionally substituted by one or more identical or different radicals from the group consisting of halogen, hydroxyl, (C₁-C₄)-alkyl, (C₁-C₄)-alkoxy and (C₁-C₄)-alkylthio, or
R³⁵ and R³⁶ together with the nitrogen atom that carries them are a 3- to 8-membered saturated or unsaturated ring;
R³⁷ is halogen, cyano, nitro, amino, hydroxyl, carboxyl, CHO, CONH₂, SO₂NH₂ or Z^{b}-R^{b};
R³⁸ is hydrogen, (C₁-C₄)-alkyl, (C₂-C₄)-alkenyl or (C₂-C₄)-alkynyl;
R³⁹ is halogen, cyano, nitro, amino, hydroxyl, carboxyl, phosphoryl, CHO, CONH₂, SO₂NH₂ or Z^{c}-R^{c};
R^{a} is a (C₂-C₂₀)-alkyl radical whose carbon chain is interrupted once or more than once by oxygen atoms, is heterocyclyl or a hydrocarbon radical, where the two last-mentioned radicals are optionally substituted by one or more identical or different radicals from the group consisting of halogen, cyano, nitro, amino, hydroxyl, mono- and di-[(C₁-C₄)-alkyl]amino;
R^{b}, R^{c} are identical or different and are a (C₂-C₂₀)-alkyl radical whose carbon chain is interrupted once or more than once by oxygen atoms, are heterocyclyl or a hydrocarbon radical, where the two last-mentioned radicals are optionally substituted by one or more identical or different radicals from the group consisting of halogen, cyano, nitro, amino, hydroxyl, phosphoryl, (C₁-C₄)-haloalkoxy, mono- and di-[(C₁-C₄)-alkyl]amino;
Z^{a} is a divalent unit from the group consisting of O, S, CO, CS, C(O)O, C(O)S, SO, SO₂, NR^{d}, C(O)NR^{d} and SO₂NR^{d};
Z^{b}, Z^{c} are identical or different and are a direct bond or divalent unit from the group consisting of O, S, CO, CS, C(O)O, C(O)S, SO, SO₂, NR^{d}, SO₂NR^{d} and C(O)NR^{d};
R^{d} is hydrogen, (C₁-C₄)-alkyl or (C₁-C₄)-haloalkyl;
n is an integer from 0 to 4, and
m, if X is CH is an integer from 0 to 5, and if X is N, is an integer from 0 to 4;
   preferably safeners of compounds of the formula (S-VI) in which
X³ is CH;
R³⁵ is hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to three heteroatoms from the group consisting of nitrogen, oxygen and sulfur, where the six last-mentioned radicals are optionally substituted by one or more identical or different substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R³⁶ is hydrogen, (C₁-C₆)-alkyl, (C₂-C₆)-alkenyl, (C₂-C₆)-alkynyl, where the three last-mentioned radicals are optionally substituted by one or more identical or different substituents from the group consisting of halogen, hydroxyl, (C₁-C₄)-alkyl, (C₁-C₄)-alkoxy and (C₁-C₄)-alkylthio;
R³⁷ is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R³⁸ is hydrogen;
R³⁹ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n is 0, 1 or 2 and
m is 1 or 2.

In particular compounds of the type of the acylsulfamoylbenzamides of the formula (S-VII) below, which are known, for example from WO-A-99/16744,

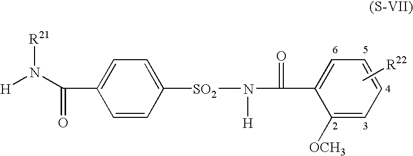

in which
R²¹=cyclopropyl and R²²=H (S3-1=4-cyclopropylaminocarbonyl-N-(2-methoxy-benzoyl)benzenesulfonamide, cyprosulfamide),
   R²¹=cyclopropyl and R²²=5—Cl (S3-2),
   R²¹=ethyl and R²²=H(S3-3),
   R²¹=isopropyl and R²²=5—Cl (S3-4) and
R²¹=isopropyl and R²²=H(S3-5=4-isopropylaminocarbonyl-N-(2-methoxybenzoyl)benzenesulfonamide);
   e) compounds of the type of the N-acylsulfamoylphenylureas of the formula (S-VIII), which are known, for example, from EP-A-365484,

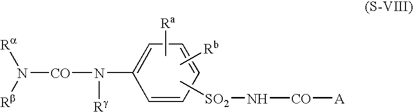

in which
A is a radical from the group consisting of

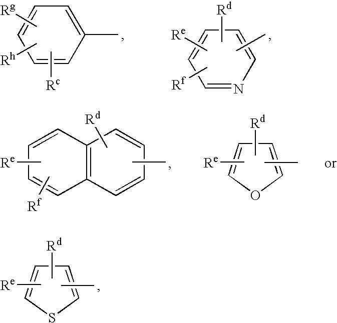

R^{α} and R^{β} independently of one another are hydrogen, C₁-C₈-alkyl, C₃-C₈-cycloalkyl, C₃-C₆-alkenyl, C₃-C₆-alkynyl,

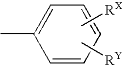

or C₁-C₄-alkoxy which is substituted by

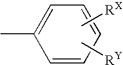

or C₁-C₄-alkoxy, or
R^{α} and R^{β} together are a C₄-C₆-alkylene bridge or a C₄-C₆-alkylene bridge which is interrupted by oxygen, sulfur, SO, SO₂, NH or —N(C₁-C₄-alkyl)-,
R^{γ} is hydrogen or C₁-C₄-alkyl,
R^{a} and R^{b} independently of one another are hydrogen, halogen, cyano, nitro, trifluoromethyl, C₁-C₄-alkyl, C₁-C₄-alkoxy, C₁-C₄-alkylthio, C₁-C₄-alkylsulfinyl, C₁-C₄-alkylsulfonyl, —COOR^{j}, —CONR^{k}R^{m}, —CORⁿ, —SO₂NR^{k}R^{m} or —OSO₂—C₁-C₄-alkyl, or R^{a} and R^{b} together are a C₃-C₄-alkylene bridge which may be substituted by halogen or C₁-C₄-alkyl, or a C₃-C₄-alkenylene bridge which may be substituted by halogen or C₁-C₄-alkyl, or a C₄-alkadienylene bridge which may be substituted by halogen or C₁-C₄-alkyl, and
R^{g} and R^{h} independently of one another are hydrogen, halogen, C₁-C₄-alkyl, trifluoromethyl, methoxy, methylthio or —COOR^{j}, where
R^{c} is hydrogen, halogen, C₁-C₄-alkyl or methoxy,
R^{d} is hydrogen, halogen, nitro, C₁-C₄-alkyl, C₁-C₄-alkoxy, C₁-C₄-alkylthio, C₁-C₄-alkylsulfinyl, C₁-C₄-alkylsulfonyl, —COOR^{j} or —CONR^{k}R^{m},
R^{e} is hydrogen, halogen, C₁-C₄-alkyl, —COOR^{j}, trifluoromethyl or methoxy, or R^{d} and R^{e} together are a C₃-C₄-alkylene bridge,
R^{f} is hydrogen, halogen or C₁-C₄-alkyl,
R^{X} and R^{Y} independently of one another are hydrogen, halogen, C₁-C₄-alkyl, C₁-C₄-alkoxy, C₁-C₄-alkylthio, —COOR⁴, trifluoromethyl, nitro or cyano,
R^{j}, R^{k} and R^{m} independently of one another are hydrogen or C₁-C₄-alkyl,
R^{k} and R^{m} together are a C₄-C₆-alkylene bridge or a C₄-C₆-alkylene bridge which is interrupted by oxygen, NH or —N(C₁-C₄-alkyl)-, and
Rⁿ is C₁-C₄-alkyl, phenyl or phenyl which is substituted by halogen, C₁-C₄-alkyl, methoxy, nitro or trifluoromethyl;
   preferred safeners of the formula (S-VIII) are
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea,
   including the stereoisomers and the agriculturally customary salts.

Unless specifically defined otherwise, the following definitions generally apply to the radicals in the formulae (S-II) to (S-VIII).

In the carbon skeleton, the radicals alkyl, alkoxy, haloalkyl, haloalkoxy, alkylamino and alkylthio and the corresponding unsaturated and/or substituted radicals may in each case be straight-chain or branched.

Alkyl radicals, including in the composite meanings, such as alkoxy, haloalkyl, etc., preferably have 1 to 4 C-atoms and are, for example, methyl, ethyl, n- or isopropyl, n-, iso-, tert- or 2-butyl. Alkenyl and alkynyl radicals have the meaning of the unsaturated radicals which are possible and correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl. Alkynyl is, for example, propargyl, but-2-yn-1-yl, but-3-yn-1-yl, 1-methylbut-3-yn-1-yl. “(C₁-C₄)-Alkyl” is the short notation of alkyl having 1 to 4 C-atoms; this applies correspondingly to other general radical definitions where the ranges of the possible number of C-atoms are indicated in brackets.

Cycloalkyl is preferably a cyclic alkyl radical having 3 to 8, preferably 3 to 7, particularly preferably 3 to 6, C-atoms, for example cyclopropyl, cyclobutyl, cyclopentyl and cyclohexyl. Cycloalkenyl and cycloalkynyl refer to the corresponding unsaturated compounds.

Halogen is fluorine, chlorine, bromine or iodine. Haloalkyl, haloalkenyl and haloalkynyl are alkyl, alkenyl and alkynyl, respectively, which are partially or fully substituted by halogen, preferably by fluorine, chlorine and/or bromine, in particular by fluorine or chlorine, for example CF₃, CHF₂, CH₂F, CF₂CF₃, CH₂CHFCl, CCl₃, CHCl₂, CH₂CH₂Cl. Haloalkoxy is, for example, OCF₃, OCHF₂, OCH₂F, OCF₂CF₃, OCH₂CF₃ and OCH₂CH₂Cl. This applies correspondingly to other halogen-substituted radicals.

A hydrocarbon radical may be an aromatic or an aliphatic hydrocarbon radical, where an aliphatic hydrocarbon radical is generally a straight-chain or branched saturated or unsaturated hydrocarbon radical having preferably 1 to 18, particularly preferably 1 to 12, C-atoms, for example alkyl, alkenyl or alkynyl.

An aliphatic hydrocarbon radical is preferably alkyl, alkenyl or alkynyl having up to 12 C-atoms; this applies correspondingly to an aliphatic hydrocarbon radical in a hydrocarbonoxy radical.

Aryl is generally a mono-, bi- or polycyclic aromatic system having preferably 6-20 C-atoms, with preference 6 to 14 C-atoms, particularly preferably 6 to 10 C-atoms, for example phenyl, naphthyl, tetrahydronaphthyl, indenyl, indanyl, pentalenyl and fluorenyl, particularly preferably phenyl.

A heterocyclic ring, heterocyclic radical or heterocyclyl is a mono-, bi- or polycyclic ring system which is saturated, unsaturated and/or aromatic and contains one or more, preferably 1 to 4, heteroatoms, preferably from the group consisting of N, S and O.

Preference is given to saturated heterocycles having 3 to 7 ring atoms and one or two heteroatoms from the group consisting of N, O and S, where the chalcogens are not adjacent. Particular preference is given to monocyclic rings having 3 to 7 ring atoms and one heteroatom from the group consisting of N, O and S, and also to morpholine, dioxolane, piperazine, imidazoline and oxazolidine. Very particularly preferred saturated heterocycles are oxirane, pyrrolidone, morpholine and tetrahydrofuran. Preference is also given to partially unsaturated heterocycles having 5 to 7 ring atoms and one or two heteroatoms from the group consisting of N, O and S. Particular preference is given to partially unsaturated heterocycles having 5 or 6 ring atoms and one heteroatom from the group consisting of N, O and S. Very particularly preferred partially unsaturated heterocycles are pyrazoline, imidazoline and isoxazoline.

Preference is also given to heteroaryl, for example mono- or bicyclic aromatic heterocycles having 5 to 6 ring atoms which contain one to four heteroatoms from the group consisting of N, O, S, where the chalcogens are not adjacent. Particular preference is given to monocyclic aromatic heterocycles having 5 or 6 ring atoms which contain a heteroatom from the group consisting of N, O and S, and also pyrimidine, pyrazine, pyridazine, oxazole, thiazole, thiadiazole, oxadiazole, pyrazole, triazole and isoxazole. Very particular preference is given to pyrazole, thiazole, triazole and furan.

Substituted radicals, such as substituted hydrocarbon radicals, for example substituted alkyl, alkenyl, alkynyl, aryl, such as phenyl, and arylalkyl, such as benzyl, or substituted heterocyclyl are a substituted radical derived from the unsubstituted skeleton, where the substituents are preferably one or more, preferably 1, 2 or 3, in the case of Cl and F also up to the maximum possible number, of substituents from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino and alkylsulfinyl, haloalkylsulfinyl, alkylsulfonyl, haloalkylsulfonyl and, in the case of cyclic radicals, also alkyl and haloalkyl, and also unsaturated aliphatic substituents corresponding to the saturated hydrocarbon-containing substituents mentioned, preferably alkenyl, alkynyl, alkenyloxy, alkynyloxy. In the case of radicals having C-atoms, preference is given to those having 1 to 4 C-atoms, in particular 1 or 2 C-atoms. In general, preference is given to substituents from the group consisting of halogens, for example, fluorine or chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Mono- or disubstituted amino is a chemically stable radical from the group of the substituted amino radicals which are N-substituted, for example, by one or two identical or different radicals from the group consisting of alkyl, alkoxy, acyl and aryl; preferably monoalkylamino, dialkylamino, acylamino, arylamino, N-alkyl-N-arylamino and also N-heterocycles. Preference is given here to alkyl radicals having 1 to 4 C-atoms. Here, aryl is preferably phenyl. Here, substituted aryl is preferably substituted phenyl. For acyl, the definition given further below applies, preferably (C₁-C₄)-alkanoyl. This applies correspondingly to substituted hydroxylamino or hydrazino.

Optionally substituted phenyl is preferably phenyl which is unsubstituted or mono- or polysubstituted, preferably up to trisubstituted, in the case of halogens such as Cl and F also up to pentasubstituted, by identical or different radicals from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyls, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

An acyl radical is a radical of an organic acid having preferably up to 6 C-atoms, for example the radical of a carboxylic acid and radicals of acids derived thereform, such as thiocarboxylic acid, optionally N-substituted iminocarboxylic acids, or the radical of carbonic monoesters, optionally N-substituted carbaminic acids, sulfonic acids, sulfinic acids, phosphonic acids, phosphinic acids. Acyl is, for example, formyl, alkylcarbonyl, such as (C₁-C₄-alkyl)carbonyl, phenylcarbonyl, where the phenyl ring may be substituted, for example as indicated above for phenyl, or alkyloxycarbonyl, phenyloxycarbonyl, benzyloxycarbonyl, alkylsulfonyl, alkylsulfinyl or N-alkyl-1-iminoalkyl.

The formulae (S-II) to (S-VIII) also embrace all stereoisomers in which the atoms are linked in the same topological manner, and mixtures thereof. Such compounds contain one or more asymmetric C-atoms or else double bonds, which are not specifically indicated in the general formulae. The possible stereoisomers, defined by their specific spatial form, such as enantiomers, diastereomers, Z and E isomers, can be obtained by customary methods from mixtures of the stereoisomers or else be prepared by stereoselective reactions in combination with the use of stereochemically pure starting materials.

The compounds of the formula (S-II) are known, for example, from EP-A-0333131 (ZA-89/1960), EP-A-0269806 (U.S. Pat. No. 4,891,057), EP-A-0346620 (AU-A-89/34951), EP-A-0174562, EP-A-0346620 (WO-A-91/08202), WO-A-91/07874 or WO-A-95/07897 (ZA 94/7120) and the literature cited therein or can be prepared by or analogously to the processes described therein. The compounds of the formula (S-III) are known from EP-A-0086750, EP-A-094349 (U.S. Pat. No. 4,902,340), EP-A-0191736 (U.S. Pat. No. 4,881,966) and EP-A-0492366 and the literature cited therein and can be prepared by or analogously to the processes described therein. Some compounds are furthermore described in EP-A-0582198 and WO-A-02/34048. The compounds of the formula (S-IV) are known from numerous patent applications, for example U.S. Pat. No. 4,021,224 and U.S. Pat. No. 4,021,229. Compounds of the subgroup b) are furthermore known from CN-A-87/102789, EP-A-365484 and also from “The Pesticide Manual”, 11th to 13th edition, British Crop Protection Council and the Royal Society of Chemistry (1997). The compounds of the subgroup c) are described in WO-A-97/45016, those of subgroup d) in WO-A-99/16744, (in particular in EP-A-365484). The publications cited contain details of preparation processes and starting materials and mention preferred compounds. These publications and all others referenced herein are expressly incorporated into the present description by way of reference.

The safeners of the preceding groups a) to e) reduce or prevent phytotoxic effects which may occur on using the herbicidal compositions according to the invention in useful crop plants, without the effectiveness of the herbicides against harmful plants being reduced. Through this, the field of use of the herbicides can be greatly enlarged and the use of herbicides which hitherto could only be used to a limited extent or insufficiently successfully, i.e. of combinations which, without safeners, resulted, in low dosages with a narrow spectrum of action, in unsatisfactory control of the harmful plants, is possible in particular by the use of safeners.

Particular preference is given, as safeners in the formulations according to the invention, to, inter alia: 4-dichloroacetyl-1-oxa-4-azaspiro[4.5]decane (AD-67), 1-dichloroacetylhexahydro-3,3,8a-trimethylpyrrolo[1,2-a]pyrimidin-6(2H)-one (dicyclonone, BAS-145138), 4-dichloroacetyl-3,4-dihydro-3-methyl-2H-1,4-benzoxazine (benoxacor), cloquintocet, 1-methylhexyl 5-chloroquinolin-8-oxyacetate (cloquintocet-mexyl), α-(cyanomethoxyimino)phenylacetonitrile (cyometrinil), 2,2-dichloro-N-(2-oxo-2-(2-propenylamino)ethyl)-N-(2-propenyl)acetamide (DKA-24), 2,2-dichloro-N,N-di(2-propenyl)acetamide (dichloromid), N-(4-methyl phenyl)-N′-(1-methyl-1-phenylethyl)urea (dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoxyimino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-291.48), methyl 1-(2-chlorophenyl)-5-phenyl-1H-pyrazole-3-carboxylate, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide and N-(2-methoxybenzoyl)-4-[(methylaminocarbonyl)amino]benzenesulfonamide.

Very particular preference is given to the safeners mefenpyr-diethyl, cloquintocet-mexyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide or fenchlorazole-ethyl; very particularly preferred are in particular mefenpyr-diethyl, cloquintocet-mexyl or isoxadifen-ethyl.

Preferred herbicide/safener mixtures are combinations of the following compounds with one another:

a) compounds which are effective as ACCase inhibitors, such as alloxydim, butroxydim, clethodim, clodinafop-propargyl, cycloxydim, cyhalofop-butyl, diclofop-methyl, fenoxaprop, fenoxaprop-ethyl, fenoxaprop-P, fenoxaprop-P-ethyl, fluazifop, fluazifop-P-butyl, fluazifop-butyl, haloxyfop, haloxyfop-P, haloxyfop-etotyl, haloxyfop-P-methyl, metamifop, profoxydim, propaquizafop, quizalofop-P-tefuryl, quizalofop-P-ethyl, sethoxydim, tepraloxydim, tralkoxydim and isoxapyrifop,
b) compounds which are effective as p-hydroxyphenyl pyruvate dioxygenase (HPPD) inhibitors, such as benzobicyclon, benzofenap, isoxaflutole and the diketonitriles thereof, mesotrione, pyrazolynate, pyrazoxyfen, sulcotrione and isoxachlortole,
c) compounds of the different active compound groups, such as atrazine, acetochlor, aclonifen, alachlor, amidochlor, amidosulfuron, azimsulfuron, bentazon, bensulfuron(-methyl), bromoxynil (octanoate/heptanoate), butachlor, bispyribac, chlorsulfuron, chlorimuron, clomazone, clopyralid, cinosulfuron, cyclosulfamuron, 2,4-D-ester, 2,4-DB-ester, 2,4-DP-ester, CMPP-ester, MCPA-ester, MCPB, EPTC, desmedipham, diflufenican, dicamba, ethoxysulfuron, ethofumesate, flazasulfuron, florasulam, flucarbazone, flumetsulam, flufenacet, fluoroglycofen, fluoroxypyr, flupyrsulfuron, foramsulfuron, flumioxazin, flumiclorac, fomesafen, glufosinate, glyphosate, imazapyr, imazosulfuron, iodosulfuron, iodosulfuron-methyl, ioxynil (octanoate), lactofen, halosulfuron, imazamox, imazapic, imazapyr, imazethapyr, imazaquin, metosulam, mesosulfuron(-methyl), (S-)metolachlor, metsulfuron-methyl, metamitron, nicosulfuron, oxyfluorfen, pendimethalin, phenmedipham, picloram, pinoxaden, primisulfuron-methyl, prosulfuron, propanil, propoxycarbazone, pyrazosulfuron(-methyl), rimsulfuron, sulfentrazone, sulfosulfuron, sulfometuron, terbuthylazine, thifensulfuron, triasulfuron, tribenuron, triclopyr, triflusulfuron-methyl, trifluralin, tritosulfuron, topramezone, oxazinone, oxadiargyl, metribuzin, and the salts thereof, for example the sodium salts.
d) compounds which are effective as safeners, such as AD 67 (4-(dichloroacetyl)-1-oxa-4-azaspiro[4.5]decane), benoxacor, CL 304,415 (4-carboxymethylchroman-4-carboxylic acid), cloquintocet, cloquintocet-mexyl, cyprosulfamide, dichlormid, dicyclonone, DKA-24 (N1,N2-diallyl-N2-dichloroacetylglycinamide), fenchlorazole, fenchlorazole-ethyl, fenclorim, flurazole, fluxofenim, furilazole, isoxadifen-ethyl, mefenpyr-diethyl, MG 191 (2-dichloromethyl-2-methyl-1,3-dioxolane), naphthalic anhydride (naphthalene-1,8-dicarboxylic anhydride), oxabetrinil and TI-35 (1-dichloroacetylazepane).

In an additional embodiment, different herbicides can, for example, be combined with one another, for example fenoxaprop-P-ethyl+ioxynil octanoate, diclofop-methyl+bromoxynil octanoate, CMPP+bromoxynil octanoate, MCPA+ioxynil octanoate, bromoxynil octanoate+bromoxynil heptanoate, bromoxynil octanoate+bromoxynil heptanoate+MCPA, bromoxynil octanoate+bromoxynil heptanoate+2,4-D, phenmedipham+desmedipham, phenmedipham+desmedipham+ethofumesate, metamitron+ethofumesate, phenmedipham+ethofumesate+metamitron, fenoxaprop-P-ethyl+iodosulfuron-methyl-sodium, fenoxaprop-P-ethyl+diclofop-methyl, fenoxaprop-P-ethyl+iodosulfuron-methyl-sodium+diclofop-methyl.

The following combinations are particularly preferred: foramsulfuron+iodosulfuron-methyl-sodium+isoxadifen-ethyl, iodosulfuron-methyl-sodium+isoxadifen-ethyl, foramsulfuron+isoxadifen-ethyl, fenoxaprop-P-ethyl+ethoxysulfuron+isoxadifen-ethyl, ethoxysulfuron+isoxadifen-ethyl, fenoxaprop-P-ethyl+isoxadifen-ethyl, iodosulfuron-methyl-sodium+mesosulfuron-methyl+mefenpyr-diethyl, mesosulfuron-methyl+mefenpyr-diethyl, iodosulfuron-methyl-sodium+mefenpyr-diethyl, fenoxaprop-P-ethyl+mefenpyr-diethyl, fenoxaprop-P-ethyl+diclofop-methyl+mefenpyr-diethyl, diclofop-methyl+mefenpyr-diethyl, diclofop-methyl+sethoxydim+mefenpyr-diethyl, sethoxydim+mefenpyr-diethyl, fenoxaprop-P-ethyl+isoproturon+mefenpyr-diethyl, isoproturon+mefenpyr-diethyl, clodinafop-propargyl+cloquintocet-mexyl, fenoxaprop-ethyl+fenchlorazole-ethyl, fenoxaprop-P-ethyl+fenchlorazole-ethyl, flucarbazone+cyprosulfamide, foramsulfuron+cyprosulfamide, iodosulfuron(-methyl)+cyprosulfamide, metosulam+cyprosulfamide, metsulfuron(-methyl)+cyprosulfamide, nicosulfuron+cyprosulfamide, primisulfuron(-methyl)+cyprosulfamide, prosulfuron+cyprosulfamide, thifensulfuron+cyprosulfamide, tribenuron+cyprosulfamide, cloransulam-methyl+cyprosulfamide, chlorimuron+cyprosulfamide, ethoxysulfuron+cyprosulfamide, flazasulfuron+cyprosulfamide, florasulam+cyprosulfamide, flumetsulam+cyprosulfamide, halosulfuron+cyprosulfamide, imazamox+cyprosulfamide, imazapic+cyprosulfamide, imazapyr+cyprosulfamide, imazethapyr+cyprosulfamide, mesosulfuron+cyprosulfamide, propoxycarbazone+cyprosulfamide, sulfosulfuron+cyprosulfamide, amidosulfuron+cyprosulfamide, chlorsulfuron+cyprosulfamide, imazaquin+cyprosulfamide, triasulfuron+cyprosulfamide, sulfometuron+cyprosulfamide, cyclosulfamuron+cyprosulfamide, flupyrsulfuron+cyprosulfamide, pyrazosulfuron+cyprosulfamide, azimsulfuron+cyprosulfamide, bensulfuron+cyprosulfamide, bispyribac+cyprosulfamide, rimsulfuron+cyprosulfamide, tritosulfuron+cyprosulfamide, sulcotrione+cyprosulfamide, clomazone+cyprosulfamide, mesotrione+cyprosulfamide, topramezone+cyprosulfamide, metribuzin+cyprosulfamide, bentazon+cyprosulfamide, bromoxynil+cyprosulfamide, propanil+cyprosulfamide, atrazine+cyprosulfamide, terbuthylazine+cyprosulfamide, EPTC+cyprosulfamide, tepraloxydim+cyprosulfamide, clethodim+cyprosulfamide, alloyxdim+cyprosulfamide, sethoxydim+cyprosulfamide, tralkoxydim+cyprosulfamide, clodinafop-propargyl+cyprosulfamide, cyhalofop-butyl+cyprosulfamide, diclofop-methyl+cyprosulfamide, fenoxaprop-P-ethyl+cyprosulfamide, fluazifop-P-butyl+cyprosulfamide, haloxyfop-methyl+cyprosulfamide, haloxyfop-etotyl+cyprosulfamide, haloxyfop-R-methyl+cyprosulfamide, haloxyfop-ethoxyethyl+cyprosulfamide, propaquizafop+cyprosulfamide, quizalofop-P-tefuryl+cyprosulfamide, quizalofop-P-ethyl+cyprosulfamide, acetochlor+cyprosulfamide, S-metolachlor+cyprosulfamide, flumioxazin+cyprosulfamide, flumiclorac+cyprosulfamide, fomesafen+cyprosulfamide, sulfentrazone+cyprosulfamide, dicamba+cyprosulfamide, MCPA+cyprosulfamide, MCPB+cyprosulfamide, 2,4-D+cyprosulfamide, clopyralid+cyprosulfamide, fluoroxypyr+cyprosulfamide, picloram+cyprosulfamide, triclopyr+cyprosulfamide, glufosinate+cyprosulfamide, glyphosate+cyprosulfamide and pendimethalin+cyprosulfamide.

The safener:herbicide ratio by weight can vary within wide limits and preferably ranges from 1:100 to 100:1, in particular from 1:100 to 50:1, very particularly preferably 1:10 to 10:1. The optimum amounts of herbicide(s) and safener(s) in each case usually depend on the type of herbicide and/or on the safener used and also on the species of crop to be treated.

### Fungicides

The agrochemical active compounds may also be fungicides, for example

inhibitors of nucleic acid synthesis, in particular
benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid;
   inhibitors of mitosis and cell division, in particular
benomyl, carbendazim, diethofencarb, fuberidazole, pencycuron, thiabendazole, thiophanate-methyl, zoxamide;
   inhibitors of the respiratory chain complex I, in particular
diflumetorim;
   inhibitors of the respiratory chain complex II, in particular
boscalid, carboxin, fenfuram, flutolanil, furametpyr, mepronil, oxycarboxin, penthiopyrad, thifluzamide;
   inhibitors of the respiratory chain complex III, in particular
azoxystrobin, cyazofamid, dimoxystrobin, enestrobin, famoxadone, fenamidone, fluoxastrobin, cresoxim-methyl, metominostrobin, orysastrobin, pyraclostrobin, picoxystrobin, trifloxystrobin;
   uncouplers, in particular
dinocap, fluazinam;
   inhibitors of ATP production, in particular
fentin acetate, fentin chloride, fentin hydroxide, silthiofam;
   inhibitors of amino acid and protein biosynthesis, in particular
andoprim, blasticidin-S, cyprodinil, kasugamycin, kasugamycin hydrochloride hydrate, mepanipyrim, pyrimethanil;
   inhibitors of signal transduction, in particular
fenpiclonil, fludioxonil, quinoxyfen;
   inhibitors of lipid and membrane synthesis, in particular
chlozolinate, iprodione, procymidone, vinclozolin,
ampropylfos, ampropylfos potassium, edifenphos, iprobenfos (IBP),
isoprothiolane, pyrazophos,
tolclofos-methyl, biphenyl,
iodocarb, propamocarb, propamocarb hydrochloride;
   inhibitors of ergosterol biosynthesis, in particular
fenhexamide,
azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine,
naftifine, pyributicarb, terbinafine;
   inhibitors of cell wall synthesis, in particular
benthiavalicarb, bialaphos, dimethomorph, flumorph, iprovalicarb, polyoxins, polyoxorim, validamycin A;
   inhibitors of melanin biosynthesis, in particular
carpropamid, diclocymet, fenoxanil, phthalide, pyroquilon, tricyclazole;
   resistance inducers, in particular
acibenzolar-S-methyl, probenazole, tiadinil;
   multisite, in particular
captafol, captan, chlorothalonil, copper salts, such as: copper hydroxide, copper naphthenate, copper oxychloride, copper sulfate, copper oxide, oxine-copper and Bordeaux mixture, dichlorfluanid, dithianon, dodine, dodine free base, ferbam, folpet, fluorfolpet, guazatine, guazatine acetate, iminoctadine, iminoctadine albesilate, iminoctadine triacetate, mancopper, mancozeb, maneb, metiram, metiram zinc, propineb, sulfur and sulfur preparations comprising calcium polysulfide, thiram, tolylfluanid, zineb, ziram;
   fungicides with unknown mechanism, in particular
amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat metilsulfate, diphenylamine, ethaboxam, ferimzone, flumetover, flusulfamide, fluopicolide, fluoroimide, hexachlorobenzene, 8-hydroxyquinoline sulfate, irumamycin, methasulfocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulfonyl)pyridine, N-(4-chloro-2-nitrophenyl)-N-ethyl-4-methylbenzene-sulfonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-α-(methoxy-methylene)benzeneacetate, 4-chloro-α-propynyloxy-N-[2-[3-methoxy-4-(2-propynyloxy)phenyl]ethyl]benzeneacetamide, (2S)-N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluoro-phenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyran-4-one, N-{(Z)-[(cyclopropylmethoxy)imino][6-(difluoromethoxy)-2,3-difluorophenyl]methyl}-2-benzeneacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-O-(methoxyimino)-N-methyl-αE-benzeneacetamide, N-{2-[3-chloro-5-(trifluormethyl)pyridin-2-yl]ethyl}-2-(trifluoromethyl)benzeneamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)-methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide.

The agrochemical active compounds can also be bactericides, for example bronopol, dichlorophen, nitrapyrin, nickel dimethyldithiocarbamate, kasugamycin, octhilinone, furancarboxylic acid, oxytetracycline, probenazole, streptomycin, tecloftalam, copper sulfate and other copper compositions.

The fungicides (bactericides) listed above are, for example, known from “The Pesticide Manual”, 12th edition (2000) and 13th edition (2003), The British Crop Protection Council, or the literature references listed after the individual active compounds.

### Insecticides

The agrochemical active compounds may also be insecticides/acaricides and/or nematicides, for example

acetylcholinesterase (AChE) inhibitors
carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate;
organophosphates,
for example acephate, azamethiphos, azinphos (-methyl, -ethyl), bromo-phosethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-5-methylsulfone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, trichlorfon, vamidothion;
   sodium channel modulators/voltage-dependent sodium channel blockers
pyrethroides,
for example acrinathrin, allethrin (d-cis-trans, d-trans), beta-cyfluthrin, bifenthrin, bioallethrin, bioallethrin-5-cyclopentenyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum);
DDT;
oxadiazines,
for example indoxacarb;
semicarbazones,
for example metaflumizone (BAS3201);
   acetylcholine receptor agonists/antagonists
chloronicotinyls,
for example acetamiprid, clothianidin, dinotefuran, imidacloprid, nitenpyram, nithiazine, thiacloprid, thiamethoxam
nicotine, bensultap, cartap;
   acetylcholine receptor modulators
spinosyns,
for example spinosad;
   GABA-controlled chloride channel antagonists
organochlorines,
for example camphechlor, chlordane, endosulfan, gamma-HCH, HCH, heptachlor, lindane, methoxychlor;
fiproles,
for example acetoprole, ethiprole, fipronil, pyrafluprole, pyriprole, vaniliprole;
   chloride channel activators
mectins,
for example abamectin, emamectin, emamectin benzoate, ivermectin, lepimectin, milbemycin;
   juvenile hormone mimics,
for example diofenolan, epofenonane, fenoxycarb, hydroprene, kinoprene, methoprene, pyriproxyfen, triprene;
   ecdysone agonists/disruptors
diacylhydrazines,
for example chromafenozide, halofenozide, methoxyfenozide, tebufenozide;
   inhibitors of chitin biosynthesis
benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron;
buprofezin;
cyromazine;
   inhibitors of oxidative phosphorylation, ATP disruptors
diafenthiuron,
organotin compounds,
for example azocyclotin, cyhexatin, fenbutatin oxide;
   uncouplers of oxidative phosphorylation by interruption of the H-proton gradient
pyrroles,
for example chlorfenapyr;
dinitrophenols,
for example binapacryl, dinobuton, dinocap, DNOC;
   Site-I electron transport inhibitors
METIs,
for example fenazaquin, fenpyroximate, pyrimidifen, pyridaben, tebufenpyrad, tolfenpyrad,
hydramethylnon,
dicofol;
   Site-II electron transport inhibitors
rotenone;
   Site-III electron transport inhibitors
acequinocyl, fluacrypyrim;
   microbial disruptors of the insect gut membrane
Bacillus thuringiensis strains;
   inhibitors of lipid synthesis
tetronic acids,
for example spirodiclofen, spiromesifen
tetramic acids,
for example spirotetramat
carboxamides,
for example flonicamid
octopaminergic agonists,
for example amitraz;
   inhibitors of magnesium-stimulated ATPase,
propargite
nereistoxin analogs,
for example thiocyclam hydrogen oxalate or thiosultap-sodium;
   agonists of the ryanodine receptor,
benzoic acid dicarboxamides,
for example flubendiamide
anthranilamides,
for example DPX E2Y45 (3-bromo-N-{4-chloro-2-methyl-6-[(methylamino)carbonyl]phenyl}-1-(3-chloropyridin-2-yl)-1H-pyrazole-5-carboxamide);
   biologicals, hormones or pheromones
azadirachtin, Bacillus spec., Beauveria spec., codlemone, Metarrhizium spec., Paecilomyces spec., thuringiensin, Verticillium spec.;
   active compounds with unknown or nonspecific mechanisms of action
antifeedants,
for example cryolite, flonicamid, pymetrozine;
mite growth inhibitors,
for example clofentezine, etoxazole, hexythiazox;
amidoflumet, benclothiaz, benzoximate, bifenazate, bromopropylate, buprofezin, chinomethionat, chlordimeform, chlorobezilate, chloropicrin, clothiazoben, cycloprene, cyflumetofen, dicyclanil, fenoxacrim, fentrifanil, flubenzimine, flufenerim, flutenzine, gossyplure, hydramethylnon, japonilure, metoxadiazone, petroleum, piperonyl butoxide, potassium oleate, pyridalyl, sulfluramid, tetradifon, tetrasul, triarathene, verbutin.

The insecticides (acaricides, nematicides) listed above are, for example, known from “The Pesticide Manual”, 12th edition (2000) and 13th edition (2003), The British Crop Protection Council, or the literature references listed after the individual active compounds.

A particular embodiment of the invention is the joint application of insecticides (acaricides, nematicides) as agrochemically active compounds, either together or in succession.

The agrochemically active compounds mentioned above can be employed in the present invention according to their solubility. The criterium water-soluble or oil-soluble of each active compound can be found in the specialist literature; solubilities of agrochemically active compounds are listed, for example in “The Pesticide Manual”, 12th edition (2000), 13th edition (2003) and 14th edition (2006), The British Crop Protection Council.

For the purpose of the present invention, the sulfonylureas contained as a component in the oil suspension concentrates according to the invention are in each case to be understood as meaning all use forms, such as acids, esters, salts and isomers, such as stereoisomers and optical isomers. Thus, in addition to neutral compounds, their salts for example with inorganic and/or organic counterions are in each case meant to be included. Thus, sulfonylureas are capable of forming salts, for example, in which the hydrogen of the —SO₂—NH— group is replaced by an agriculturally suitable cation. These salts are, for example, metal salts, in particular alkali metal salts or alkaline earth metal salts, in particular sodium and potassium salts, or else ammonium salts or salts with organic amines. Salt formation may also take place by addition of an acid to basic groups, such as, for example, amino and alkylamino. Acids suitable for this purpose are strong inorganic and organic acids, for example HCl, HBr, H₂SO₄ or HNO₃. Preferred esters are the alkyl esters, in particular the C₁-C₁₀-alkyl esters, such as methyl esters.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbaminic acids, sulfonic acids, sulfinic acids, phosphonic acids, phosphinic acids.

An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br, I, alkoxy, haloalkoxy, hydroxyl, amino, nitro, cyano and alkylthio, or R^{z} is aminocarbonyl or aminosulfonyl, where the two last-mentioned radicals are unsubstituted, N-monosubstituted or N,N-disubstituted, for example by substituents from the group consisting of alkyl and aryl.

Acyl is, for example, formyl, haloalkylcarbonyl, alkylcarbonyl, such as (C₁-C₄)-alkyl-carbonyl, phenylcarbonyl, where the phenyl ring may be substituted, or alkyloxy-carbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Optionally substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl; alkynyl is, for example, propargyl, but-2-yn-1-yl, but-3-yn-1-yl, 1-methylbut-3-yn-1-yl.

Halogen is, for example, fluorine, chlorine, bromine or iodine. Haloalkyl, -alkenyl and -alkynyl are alkyl, alkenyl and alkynyl, respectively, which are partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

In addition to the components a) and b), the formulations according to the invention also comprise one or more auxiliaries and additives, for example:
(c) surfactants and/or non-surfactant polymers,
(d) organic solvents,
(e) agrochemicals, such as, for example, fertilizers,
(f) customary formulation auxiliaries, such as antifoams, antifreeze agents, evaporation inhibitors, preservatives, odorants, colorants, stabilizers, water scavengers or thickeners,
(g) tank mix components.

Thus, the formulations according to the invention may comprise as component c), for example, one or more surfactants, for example ionic, nonionic or betainic surfactants. These may be of monomeric or polymeric nature (for example graft polymers). Examples of components c) are silicone-based surfactants, such as trisiloxane surfactants, derivatives of polydimethylsiloxanes and/or silicone oils, or sugar-based surfactants, such as Atplus® 309 F (Uniqema). Further examples of components c) are (C₄-C₃₀)-(poly)alkylene oxide adducts which may, for example, be branched, linear, saturated or unsaturated, in particular of fatty alcohols and/or fatty acids and/or fatty esters. Examples of (poly)alkylene oxide adducts are Soprophor® CY8 (Rhodia), Genapol® X-060, Genapol® X-080, Genapol® X-150; Genapol® X-200, Sapogenat T® 300, Sapogenat T® 500, Genapol® T 200, Genapol T® 800 or Genagen® MEE (methyl ester ethoxylates, Clariant) and other terminally capped surfactants having a methyl, ethyl, n-propyl, isopropyl, n-butyl, tert-butyl, isobutyl, sec-butyl or acetyl group as terminal grouping, for example Genapol® X-060 methyl ether or Genapol® X-150 methyl ether.

Further examples of components c) are components which are insoluble in the continuous phase of the formulation, for example anionic surfactants, such as Hostapur® OSB (Clariant), Netzer® IS (Clariant), Galoryl® DT 201 (CFPI), Tamol® (BASF) or Morwet® D 425 (Witco). By incorporating components which are insoluble in the continuous phase or else insoluble active compounds into the formulations, dispersions are obtained. Accordingly, the present invention also includes dispersions.

As component c), the formulations may also comprise sulfosuccinates, for example of the formula (III)

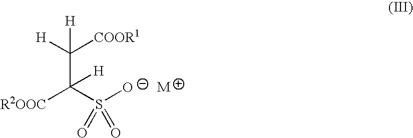

in which
R¹,R² independently of one another are identical or different unsubstituted or substituted C₁-C₃₀-hydrocarbon radicals, such as C₁-C₃₀-alkyl, or a (poly)alkylene oxide adduct, and
M^{ρ} is a cation, for example a metal cation, such as an alkali metal or alkaline earth metal cation, an ammonium cation, such as NH₄, an alkyl, alkylaryl or poly(arylalkyl)phenylammonium cation or a (poly)alkylene oxide adduct thereof, or an amino-terminated (poly)alkylene oxide adduct.

(Poly)alkylene oxide adducts for the purpose of this description are reaction products of alkoxylatable starting materials such as alcohols, amines, carboxylic acids, such as fatty acids, hydroxy- or amino-functional carboxylic esters (examples being triglycerides based on castor oil) or carboxamides with alkylene oxides, the (poly)alkylene oxide adducts having at least one alkylene oxide unit, but generally being polymeric, i.e. having 2-200, preferably 5-150, alkylene oxide units. Among the alkylene oxide units, ethylene oxide, propylene oxide and butylene oxide units, especially ethylene oxide units, are preferred. The (poly)alkylene oxide adducts described may be composed of alike or of different alkylene oxides, for example of blockwise or randomly arranged ethylene oxide and propylene oxide, so that the present specification also encompasses mixed alkylene oxide adducts of this kind.

Moreover, as component c), the formulations may also comprise non-surfactant polymers, for example polyvinyl alcohols, polyacrylates, polymalinates or polyethylene oxides.

The polymers which are present as component c) may be inorganic (for example silicates, phosphates) or organic, cationic, anionic or neutral, synthetic or natural.

Moreover, as component d), the formulations according to the invention may comprise various organic solvents, such as unpolar solvents, polar protic or aprotic dipolar solvents and mixtures thereof. Examples of such organic solvents d) are
aliphatic or aromatic hydrocarbons, for example mineral oils, paraffins or toluene, xylenes and naphthalene derivatives, in particular 1-methyl-naphthalene, 2-methylnaphthalene, mixtures of C₆-C₁₆-aromatic compounds, such as the Solvesso® group (ESSO), for example with the types Solvesso® 100 (b.p. 162-177° C.), Solvesso® 150 (b.p. 187-207° C.) and Solvesso® 200 (b.p. 219-282° C.), and C₆-C₂₀-aliphatic compounds, which may be linear or cyclic, such as the products of the Shellsol® groups, types T and K, or BP-n paraffins,
halogenated aliphatic or aromatic hydrocarbons, such as methylene chloride or chlorobenzene,
esters, such as triacetin (acetic acid triglyceride), butyrolactone, propylene carbonate, triethyl citrate and (C₁-C₂₂)alkyl phthalates, especially (C₁-C₈)alkyl phthalates, (C₁-C₁₃)alkyl maleates,
linear, branched, saturated or unsaturated C₁-C₂₀-alcohols, such as methanol, ethanol, n- and isopropanol, n-, iso-, sec- and tert-butanol, tetrahydrofurfuryl alcohol, and also pentanol, hexanol, heptanol,
ethers, such as diethyl ether, tetrahydrofuran (THF), dioxane, alkylene glycol monoalkyl ethers and dialkyl ethers, such as, for example, propylene glycol monomethyl ether, especially Dowanol® PM (propylene glycol monomethyl ether), propylene glycol monoethyl ether, ethylene glycol monomethyl ether or monoethyl ether, diglyme and tetraglyme,
amides, such as dimethylformamide (DMF), dimethylacetamide, dimethylcaprylamide/dimethylcaprinamide and N-alkylpyrrolidones,
ketones, such as the water-soluble acetone, but also water-immiscible ketones, such as, for example, cyclohexanone or isophorone,
nitriles, such as acetonitrile, propionitrile, butyronitrile and benzonitrile,
sulfoxides and sulfones, such as dimethyl sulfoxide (DMSO) and sulfolane,
   and also
oils in general, such as mineral oils or vegetable oils, such as corn oil, linseed oil and rapeseed oil.

Organic solvents which are preferred in the context of the present invention as components d) are ester oils, such as rapeseed oil methyl ester, and aliphatic or aromatic hydrocarbons, such as Solvesso® types, for example Solvesso® 200, Solvesso® 150.

Furthermore, polycarboxylic acid alkyl esters may act as solvents, those suitable being, for example, alkyl esters of low-molecular-weight di-, tri-, tetra- or else higher-functional carboxylic acids having preferably 2-20 carbon atoms. Also suitable are polymeric polycarboxylic acids, preferably those having molecular weights of up to 2000 g/mol. Examples of polycarboxylic acids are oxalic acid, malonic acid, succinic acid, glutaric acid, adipic acid, pimelic acid, sebacic acid, azelaic acid, suberic acid, maleic acid, phthalic acid, terephthalic acid, mellitic acid, trimellitic acid, polymaleic acid, polyacrylic acid and polymethacrylic acid, and also co- or terpolymers comprising maleic, acrylic and/or methacrylic acid units.

Suitable alcohol components of the polycarboxylic acid alkyl esters are, for example, alkyl alcohols, preferably monofunctional alkyl alcohols having 1-20 carbon atoms. Examples of such alkyl alcohols are methyl, ethyl, n-propyl, isopropyl, n-butyl, sec-butyl, isobutyl or tert-butyl alcohol.

The polycarboxylic acid alkyl esters preferably have the formula (I) below

R—O—OC—(CR^{α}R^{β})ₓ—CO—O—R^{δ} (I)

in which
R^{α} and R^{β} are identical or different and are H, an unsubstituted or substituted C₁-C₂₀-hydrocarbon radical, such as C₁-C₁₀-alkyl, or a group (CR′R″)_{y}—CO—OR′″, in which R′ and R″ are identical or different and are H or an unsubstituted or substituted C₁-C₂₀-hydrocarbon radical, such as C₁-C₁₀-alkyl, y is an integer from 0 to 10 and R′″ is an unsubstituted or substituted C₁-C₂₀-hydrocarbon radical, such as C₁-C₁₀-alkyl,
R^{γ} and R^{δ} are identical or different and are an unsubstituted or substituted C₁-C₂₀-hydrocarbon radical, such as C₁-C₁₀-alkyl, and x is an integer from 0 to 20.

Particularly preferred polycarboxylic acid alkyl esters are diesters of the formula (Ia) below

R^{γ}—O—OC—(CH₂)ₓ—CO—O—R^{δ} (Ia)

in which
x is an integer from 0 to 20 and
R^{γ} and R^{δ} independently of one another are identical or different and are C₁-C₆-alkyl.

Examples of polycarboxylic acid alkyl esters are oxalic acid esters, such as oxalic acid dimethyl ester, oxalic acid diethyl ester, oxalic acid di-n-propyl ester, oxalic acid diisopropyl ester and oxalic acid methyl ethyl ester, malonic acid esters, such as malonic acid dimethyl ester, malonic acid diethyl ester, malonic acid di-n-propyl ester, malonic acid diisopropyl ester and malonic acid methyl ethyl ester, succinic acid esters, such as succinic acid dimethyl ester, succinic acid diethyl ester, succinic acid di-n-propyl ester, succinic acid diisopropyl ester and succinic acid methyl ethyl ester, glutaric acid esters, such as glutaric acid dimethyl ester, glutaric acid diethyl ester, glutaric acid di-n-propyl ester, glutaric acid diisopropyl ester and glutaric acid methyl ethyl ester, and adipic acid esters, such as adipic acid dimethyl ester, adipic acid diethyl ester, adipic acid di-n-propyl ester, adipic acid diisopropyl ester and adipic acid methyl ethyl ester. Preference is give to adipic acid esters, in particular to adipic acid dimethyl ester.

The polycarboxylic acid alkyl esters can be obtained, for example, by reacting the free carboxylic acids with the alcohols, where the esters can be obtained, for example, by reacting “activated” polycarboxylic acids, such as polycarboxylic acid anhydrides or polycarbonyl (poly)chlorides, with the alcohols according to known esterification methods.

As component e), the liquid formulations according to the invention may comprise various agrochemicals. These are, for example, growth regulators or fertilizers.

As component f), the liquid formulations according to the invention may also comprise customary formulation auxiliaries, such as antifoams, antifreeze agents, evaporation inhibitors, preservatives, odorants, colorants, stabilizers, water scavengers or thickeners. Preferred formulation auxiliaries are antifreeze agents and evaporation inhibitors, such as glycerol, for example in an amount of from 2 to 10% by weight, and preservatives, for example Mergal® K9N (Riedel) or Cobate® C.

As component g), the formulations according to the invention may also comprise tank mix components. Examples of these are tank mix adjuvants, such as Telmion® (Hoechst), or vegetable oils, such as Actirob B® (Novance) or Hasten® (Victorian Chemicals), inorganic compounds, such as fertilizers, for example ammonium sulfate, ammonium nitrate, ammonium hydrogen sulfate, ureas or hydrotropics.

In general, the active compound content of the formulations according to the invention may be from 0.001 percent by weight to 80 percent by weight, higher loading also being possible in individual cases, in particular when a plurality of active compounds is used.

The auxiliaries and additives which can be used for preparing the formulations according to the invention, such as, for example, surfactants and solvents, are known in principle and are described, for example, in: McCutcheon's “Detergents and Emulsifiers Annual”, MC Publ. Corp., Ridgewood N.J.; Sisley and Wood, “Encyclopedia of Surface active Agents”, Chem. Publ. Co. Inc., N.Y. 1964; Schönfeldt, “Grenzflächenaktive Äthylenoxidaddukte” [Surface-Active Ethylene Oxide Adducts], Wiss. Verlagsgesellschaft, Stuttgart 1976; Winnacker-Küchler, “Chemische Technologie” [Chemical Technology], volume 7, C. Hanser-Verlag, Munich, 4th edition 1986.

Accordingly, the present invention also embraces suitable process(es) for preparing the formulations according to the invention.

The formulations according to the invention are generally physically and chemically stable formulations which, on dilution with water, afford spray liquors having favorable physical application properties. In addition, the formulations according to the invention preferably have favorable biological properties and can be used widely, for example for controlling unwanted vegetation.

Microcapsules of the present invention can be prepared by any desired process and analogously to known processes. The encapsulated aqueous solutions or suspensions are preferably prepared from a water-in-oil emulsion with addition of polymerizable components, if appropriate in the presence of suitable surfactant components, see, for example, U.S. Pat. No. 4,157,983 and U.S. Pat. No. 4,534,783, which are incorporated herein by reference in relevant portion.

The formulations according to the invention can be prepared, for example, as follows (working example):

An organic phase was prepared by dissolving dodecylbenzenesulfonic acid and nonionic alkylarylphenol in kerosene as solvent. The aqueous phase was prepared by dissolving glyphosate and urea/formaldehyde prepolymers in water. The two phases were then combined with stirring, forming a water-in-oil emulsion. The temperature was then increased to 40° C., and stirring was continued for 2 or more hours. The resulting product was cooled, affording a suspension of microcapsules in the organic phase, the microcapsules enclosing the aqueous medium.

The preparation of microcapsules comprising an agrochemically active compound(s) dissolved or dispersed in an oil phase can be carried out by any desired method and analogously to known methods.

The agrochemically active compounds, dissolved in water and microencapsulated, are then mixed with the agrochemically active compounds dissolved or dispersed in the oil phase, to afford the oil suspension concentrate according to the present invention.

Also contemplated in the context of the present invention is the preparation of an oil suspension concentrate according to the invention. These can be prepared by desired and/or known processes. Grinding and mixing of the components can be, as long as this is compatible with the formation or presence of the microcapsules, carried out by any desired and/or known method.

For use, the oil suspension concentrates according to the present invention may, if appropriate, be diluted in a customary manner (for example using water), to give, for example, suspensions, emulsions, suspoemulsions or solutions, preferably to give emulsions. It may be advantageous to add further agrochemically active compounds (for example tank mix partners in the form of corresponding formulations) and/or auxiliaries and additives customary for application, for example self-emulsifying oils, such as vegetable oils or paraffin oils, and/or fertilizers to obtained spray emulsions. Accordingly, the present invention also provides such herbicidal compositions based on the oil suspension concentrates according to the invention.

The oil suspension concentrates according to the invention and the use forms obtainable therefrom by dilution (all of which are referred to as “herbicidal compositions according to the invention”) generally have outstanding herbicidal activity against a broad spectrum of economically important monocotyledonous and dicotyledonous harmful plants, including species which are resistant to herbicidally active compounds such as glyphosate, glufosinate, atrazine or imidazolinone herbicides. The active compounds also act efficiently on perennial weeds which produce shoots from rhizomes, rootstocks or other perennial organs and which are difficult to control. The substances can be applied, for example, by the pre-sowing, the pre-emergence or the post-emergence method. Preferred is, for example, the application to the emerged harmful plants (for example weeds or unwanted crop plants), in particular prior to the emergence of the (wanted) crop plants.

Specific examples which may be mentioned include some representatives of the monocotyledonous and dicotyledonous weed flora which can be controlled by the compounds according to the invention, without the enumeration being a restriction to certain species.

The compositions act efficiently against, from amongst the monocotyledonous weed species, for example Avena spp., Alopecurus spp., Brachiaria spp., Digitaria spp., Lolium spp., Echinochloa spp., Panicum spp., Phalaris spp., Poa spp., Setaria spp. and also Cyperus species from the annual group and, from amongst the perennial species, Agropyron, Cynodon, Imperata and Sorghum and also perennial Cyperus species.

In the case of dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

If the herbicidal compositions according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the herbicidal compositions are applied post-emergence to the green parts of the plants, growth likewise stops drastically a very short time after the treatment and the weed plants remain at the growth stage at the point of time of application, or they die completely after a certain time, so that in this manner competition by the weeds, which is harmful to the crop plants, is eliminated at a very early point in time and in a sustained manner.

The herbicidal compositions according to the invention are advantageously distinguished by a rapidly commencing and long-lasting herbicidal action. As a rule, the rainfastness of the active compounds in the combinations according to the invention is advantageous. A particular advantage is that the dosages of the compounds (a), which are used in the combinations and are effective, can be adjusted to such a low quantity that their soil action is optimally low. Not only does this allow them to be employed in sensitive crops in the first place, but groundwater contaminations are also virtually avoided. The active compound combination according to the present invention allows the application rate of the active compounds required, to be reduced considerably.

The abovementioned properties and advantages are of benefit for weed control practice to keep agricultural crops free from undesired competing plants and thus to safeguard and/or increase the yields from the qualitative and quantitative points of view. These novel combinations markedly exceed the technical state of the art with a view to the properties described.

In addition, some of the compositions according to the invention have outstanding growth-regulatory properties in crop plants. They engage in the plant's metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without destroying the plants at the same time. Inhibition of vegetative growth is very important in a large number of monocotyledonous and dicotyledonous crops since yield losses caused by lodging can thus be reduced, or prevented completely.

By virtue of their herbicidal and plant-growth-regulatory properties, the compositions can be employed for controlling harmful plants in known crop plants or still to be developed tolerant or genetically modified crop plants. The transgenic plants are distinguished as a rule by particular, advantageous properties, such as, in addition to resistances to the compositions according to the invention, for example resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

In principle, it is not excluded that one of the oil suspension concentrates according to the invention is used in the context of a method for controlling harmful organisms, the application against harmful organisms being carried out at the sites where they occur. In general, the use of one of the oil suspension concentrates according to the invention for controlling harmful organisms is within the context of the invention. The application rate of the herbicides, for example in the case of the pyridylsulfonylureas, may vary within a wide range, for example between 0.001 g and 500 g of AS/ha (hereinbelow, AS/ha means “active substance per hectare”=based on 100% active compound). In applications with application rates of from 0.01 g to 200 g of AS/ha of the herbicides, a relatively broad spectrum of harmful plants, for example of annual and perennial mono- or dicotyledonous weeds and also of unwanted crop plants, is controlled by the pre- and post-emergence method. In the combinations according to the invention, the application rates are generally less, for example in the range of from 0.001 g to 100 g of AS/ha, preferably from 0.005 g to 50 g of AS/ha, particularly preferably from 0.01 g to 9 g of AS/ha.

The sulfonylurea-comprising oil suspension concentrates are suitable, for example, for controlling harmful plants in crops of plants, for example in economically important field crops, for example monocotyledonous field crops, such as cereals (for example wheat, barley, rye, oats), rice, corn, millet, or dicotyledonous field crops, such as sugarbeet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR soybeans or LL soybeans) and crossbreeds thereof, Phaseolus, Pisum, Vicia and Arachis, or vegetable crops from various botanical groups, such as potato, leek, cabbage, carrot, tomato, onion, and also permanent crops and plantation crops, such as pome fruit and stone fruit, berry fruit, grapevines, Hevea, bananas, sugarcane, coffee, tea, citrus fruit, nut plantations, roses, palm plantations and forest plantations. For the use of herbicide combinations, these crops are likewise preferred. Of particular interest for the herbicide combinations are especially mutant crops tolerant to the herbicides and tolerant transgenic crops, preferably corn, rice, cereals, oilseed rape and soybean, in particular soybean, which are resistant to imidazolinone herbicides, glufosinate or glyphosate.

The oil suspension concentrates can also be employed in a non-selective manner for controlling unwanted vegetation, for example in permanent crops and plantation crops, on roadsides, squares, industrial plants, airports or railway tracks, or for the burn-down application, for example in field crops, for example monocotyledonous field crops, such as cereals (for example wheat, barley, rye, oats), rice, corn, millet, or dicotyledonous field crops, such as sugarbeet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR soybean or LL soybean) and crossbreeds thereof, Phaseolus, Pisum, Vicia and Arachis, or vegetable crops from various botanical groups, such as potato, leek, cabbage, carrot, tomato, onion.

The invention is illustrated in more detail by examples, without being limited thereby.

### Example 1

Table 1 shows the composition of an oil suspension concentrate according to the invention where both a component (a) and a component (b) is encapsulated.

TABLE 1

| | Name: | Percent by weight |
|---|---|---|
| Component | Agrochemically active compound | [% by weight] |
| (a) | glyphosate isopropylammonium salt | 18 |
| | (encapsulated) | |
| (b) | flufenacet (encapsulated) | 7.2 |
| (b) | iodosulfuron-methyl-sodium (dispersed) | 0.1 |
| (b) | mefenpyr-diethyl (dissolved) | 0.3 |
| (c)-(g) | auxiliaries and additives | 74.4 |

### Example 2

Table 2 shows a composition in which only component (a) is encapsulated.

TABLE 2

| | Name: | Percent by weight |
|---|---|---|
| Component | Agrochemically active compound | [% by weight] |
| (a) | glyphosate isopropylammonium salt | 18 |
| | (encapsulated) | |
| (b) | flufenacet (dissolved) | 7.2 |
| (b) | iodosulfuron-methyl-sodium (dispersed) | 0.1 |
| (b) | mefenpyr-diethyl (dissolved) | 0.3 |
| (c)-(g) | auxiliaries and additives | 74.4 |

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

1. An oil suspension concentrate, comprising
(a) at least one agrochemically active compound in an aqueous phase, which is present in encapsulated form in an oil phase, and
(b) at least one agrochemically active compound encapsulated in an oil phase, and
(c) optionally an auxiliary and/or additive.

2. The oil suspension concentrate as claimed in claim 1, wherein said at least one active compound present in (b) comprises a sulfonylurea.

3. The oil suspension concentrate as claimed in claim 1, wherein said at least one active compound present in (b) comprises a thien-3-ylsulfonylamino(thio)carbonyltriazolin(ethi)one and/or a salt thereof.

4. The oil suspension concentrate as claimed in claim 1, wherein said at least one active compounds present in (b) comprises a phenylsulfonylurea.

5. The oil suspension concentrate as claimed in claim 1, wherein said at least active compound present in (b) comprises a dioxazinepyridylsulfonylurea and/or a salt thereof.

6. The oil suspension concentrate as claimed in claim 1, wherein said at least one active compound present in (b) comprises a phenylsulfonylaminocarbonyltriazolinone.

7. The oil suspension concentrate as claimed in claim 1, wherein said at least one active compound present in (b) comprises a propoxycarbazone and/or a salt thereof.

8. The oil suspension concentrate as claimed in claim 1, wherein microcapsules comprising the active compound (b) present in the oil phase are in dispersed or dissolved form and said microcapsules comprising the oil phase active compound (b) differ in release properties from microcapsules comprising the active compound (a) in the aqueous phase.

9. The oil suspension concentrate as claimed in claim 1, wherein chemical properties of the active compound present in the oil phase (b) differ from those of the active compound (a) present in the aqueous phase.

10. The oil suspension concentrate as claimed in claim 9, wherein the active compounds (a) and (b) differ in solubility and/or hydrolysis sensitivity.

11. The oil suspension concentrate as claimed in claim 1, wherein the active compounds (a) and (b) differ in melting point.

12. The oil suspension concentrate as claimed in claim 1, wherein the active compound (a) has a melting point of at least 120° C.

13. A method for preventing or delaying chemical degradation and/or hydrolysis, of an active compound in an agrochemical formulation comprising using an oil suspension concentrate according to claim 1 to form said formulation.

14. A method for controlling a harmful plant, which comprises applying an effective amount of an oil suspension concentrate as claimed in claim 1 to the harmful plant, a part of the plant, plant seeds and/or an area where the plant grows.

15. An oil suspension concentrate as claimed in claim 1 adapted for controlling harmful plants.

16. A method for preparing an active compound formulation comprising utilizing an oil suspension concentrate as claimed in claim 1.

17. An oil suspension concentrate as claimed in claim 2, wherein said sulfonylurea comprises a phenylsulfonylurea, a heteroarylsulfonylurea, a (het)arylsulfonylaminocarbonyltriazolinone and/or a pyridylsulfonylurea.

18. An oil concentrate suspension comprising at least two active compounds, wherein one of said compounds is more sensitive to hydrolysis and the other of said active compounds is less sensitive to hydrolysis, and wherein at least one of said two active compounds is provided in said suspension in a microencapsulation.

19. An oil concentrate suspension of claim 18, wherein said suspension comprises a water-in-oil microencapsulation, an oil-in-water microencapsulation, a water-in-oil-in-water multi microencapsulation and/or a water-in-oil-in-oil multi microencapsulation.
